(19) United States
(12) Patent Application Publication
(10) Pub. No.: US 2026/0105912 A1
(43) Pub. Date: Apr. 16, 2026

(54) HMM DECODING COMPENSATION FOR SPEECH RECOGNITION AND MULTI-STRUCTURED DECODING FOR LOW RESOURCE COMMAND RECOGNITION

(71) Applicant: Cypress Semiconductor Corporation, San Jose, CA (US)

(72) Inventor: Robert Zopf, Rancho Santa Margarita, CA (US)

(73) Assignee: Cypress Semiconductor Corporation, San Jose, CA (US)

(21) Appl. No.: 19/191,452

(22) Filed: Apr. 28, 2025

Related U.S. Application Data
(60) Provisional application No. 63/706,483, filed on Oct. 11, 2024.

(51) Int. Cl. G10L 15/16; G10L 15/14

(52) U.S. Cl. CPC G10L 15/16; G10L 15/148

(57) ABSTRACT

Described are techniques to recognize spoken wake word (WW) or command for human-machine interface using a speech recognition system that does not require any WW/command-matching speech data for training. The system uses the text or grapheme representation of the WW or commands for training before deployment. The technique includes receiving a target phrase for recognition by a speech recognition model. The technique includes analyzing a sequence of acoustic units representative of the target phrase when the target phrase is spoken to generate offline analysis data. The technique further includes constructing the speech recognition model based on the offline analysis data to decode speech signals of the target phrase according to the acoustic units. The technique further includes processing speech based on the speech recognition model to detect a presence of the target phrase.

### CROSS REFERENCE TO RELATED APPLICATIONS

This application claims the benefit of the filing date of U.S. Provisional Application No. 63/706,483 filed on Oct. 11, 2024 by Applicant Cypress Semiconductor Corporation, the disclosure of which is incorporated herein by reference in its entirety.

### TECHNICAL FIELD

The subject matter relates to the field of voice-controlled human machine interface. More specifically, but not by way of limitation, the subject matter discloses techniques for recognizing a wake-up word or phrase (collectively referred to as wake-word or WW) used to trigger voice-controlled devices as well as speech commands uttered by users to control the devices without requiring speech data specific to the target WWs or commands for training.

### BACKGROUND

Consumer electronic devices such as smartphones, desktop computers, laptops, home assistant devices, etc., are voice controlled digital devices that may be controlled by users issuing speech commands to the devices. For example, users may issue voice commands to the devices to make phone calls, send messages, play media content, obtain query responses, get news, setup reminders, invoke applications and services, etc. A voice command issued by a speaker may be interfered by voice from a competing speaker, noise, or the main speaker's own interruptions. Speech recognition systems to detect and recognize the voice commands are increasingly relying on neural networks or machine learning to improve performance. For a speech recognition system to respond accurately and timely to the voice commands with confusable phonemes, various speaker accents, and different pronunciations in adverse environmental conditions the neural networks or machine learning models may be trained based on speech data of the target WW and commands. Offline training of a speech recognition system may require the collection of speech data matching the target WW and commands. However, the training may be complex and time-consuming. The resulting system may also demand a large memory footprint and may be expensive to deploy. On the other hand, a speech recognition system that is not trained directly on the target WW and commands may not be sufficiently robust, resulting in poor performance in challenging environmental conditions.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 depicts a scenario of a user uttering a voice command including a WW followed by a command to a smartphone for the smartphone to detect and to recognize the voice command, in accordance with one aspect of the present disclosure;

FIG. 2 depicts a high-level architecture of a data-free speech recognition system, in accordance with one aspect of the present disclosure;

FIG. 3 depicts operational details of the offline training and online training of a data-free speech recognition architecture, in accordance with one aspect of the present disclosure;

FIG. 4 depicts processing details of the inference stage of a data-free speech recognition architecture using the trained acoustic unit 216 from the offline training and the recognition model 350 from the online training, in accordance with one aspect of the present disclosure;

FIG. 5 depicts another view of the inference stage of a data-free speech recognition architecture, in accordance with one aspect of the present disclosure;

FIG. 6 depicts the use of the phoneme analysis block to generate statistics based on the phonemes output by the unit matching block to generate statistics to improve the decoding of the recognize phrase in automatic speech processing (ASP) applications, in accordance with one aspect of the present disclosure;

FIG. 7 depicts a block diagram of the sequence decoding block incorporating a hidden Markov Model (HMM), in accordance with one aspect of the present disclosure.

FIG. 8A shows the time plot for the phonemes of the WW “Okay Infineon,” in accordance with one aspect of the present disclosure.

FIG. 8B shows the spectral plot for the phonemes of the WW “Okay Infineon,” in accordance with one aspect of the present disclosure.

FIG. 8C shows the annotations of the phonemes and the start times and end times for each phoneme in the WW “Okay Infineon,” in accordance with one aspect of the present disclosure;

FIG. 8D shows the posterior probability P(q=phⱼ|x) for the phoneme ‘K’ of the WW “Okay Infineon,” in accordance with one aspect of the present disclosure.

FIG. 9 depicts an example of the computation of posterior probabilities P(q=phⱼ|x) grouped by unit boundaries, in accordance with one aspect of the present disclosure;

FIG. 10 shows the matrix for the 40 phonemes used in American English plus silence class for one acoustic model, in accordance with one aspect of the present disclosure;

FIG. 11 shows a magnified view of the top left portion of the matrix of FIG. 10, in accordance with one aspect of the present disclosure;

FIG. 12 depicts the unit matching block modifying the posterior probabilities according to the computed statistics in the similarity matrix, in accordance with one aspect of the present disclosure;

FIG. 13 shows a HMM of a sequence decoding model for recognizing WWs or commands according to the computed statistics in the similarity matrix, in accordance with one aspect of the present disclosure;

FIG. 14 shows an example of the possible pronunciations and the highest confusing phonemes of each pronunciation for states in the HMM for “Okay Infineon,” in accordance with one aspect of the present disclosure;

FIG. 15 depicts the use of the decoding compensation block to improve the sequence decoding of the WWs or commands from the HMM of the word/command model 730, in accordance with one aspect of the present disclosure;

FIG. 16 shows a direct computation of P(X|λ), where the x-axis shows the observation sequence X in time and the y-axis shows the states, in accordance with one aspect of the present disclosure.

FIG. 17A depicts using the forward algorithm to evaluate P(X|λ), in accordance with one aspect of the present disclosure;

FIG. 17B depicts the using Viterbi algorithm to evaluate P(X|λ), in accordance with one aspect of the present disclosure;

FIG. 18A depicts the most likely state walk for positive data of example WWs, in accordance with one aspect of the present disclosure;

FIG. 18B depicts the most likely state walk for negative data of example WWs, in accordance with one aspect of the present disclosure;

FIG. 19 depicts the most likely state walk s_{ML} for negative data of example WWs as in FIG. 18B but highlighted to show the state jumps, in accordance with one aspect of the present disclosure;

FIG. 20 depicts the most likely state walk s_{ML} for negative data of example WWs as in FIG. 18B to show the number of frames the s_{ML} remains in each state, in accordance with one aspect of the present disclosure;

FIG. 21 depicts the top-1 statistics of the phonemes for the WW ‘Okay Infineon,’ in accordance with one aspect of the present disclosure;

FIG. 22 depicts sequence decoding structures for a user-defined command set, in accordance with one aspect of the present disclosure;

FIG. 23A depicts the constituent words for the WW “Okay Infineon” recognized by the sequence decoding structure for WWs of FIG. 22, in accordance with one aspect of the present disclosure;

FIG. 23B depicts the constituent words for the simple commands “Take a picture,” and “Set alarm clock to snooze,” recognized by the sequence decoding structure for simple commands of FIG. 22, in accordance with one aspect of the present disclosure;

FIG. 23C depicts the constituent common sub-command and the four second stage sub-commands for the four compound commands 1) “Turn the light on in the living room;” 2) “Turn the light on on the porch;” 3) “Turn the light on behind the study desk;” and 4) “Turn the light on by the stove,” recognized by the sequence decoding structure for compound commands of FIG. 22, in accordance with one aspect of the present disclosure;

FIG. 23D depicts the constituent number range and a unit for the number-based entity “two hundred forty seven degrees” recognized by the sequence decoding structure for decoding a large number range followed by a unit of FIG. 22, in accordance with one aspect of the present disclosure;

FIG. 23E depict the constituent simple command, number range, and a unit for the complex command “Set oven temperature to two hundred forty seven degrees,” recognized by the sequence decoding structure for complex commands of FIG. 22, in accordance with one aspect of the present disclosure;

FIG. 24 illustrates a flow diagram of a method for constructing the sequence decoding structures to recognize WWs or commands from a user-defined command set, in accordance with one aspect of the present disclosure;

FIG. 25 depicts the recognition model for the WW detecting “Okay Infineon” and two following recognition models for CMD1 and CMD 2 evaluating a follow-on command, in accordance with one aspect of the present disclosure;

FIG. 26 depicts the recognition model for the WW detecting “Okay Infineon” and two following recognition models for CMD1 and CMD 2 evaluating a follow-on command with a state compensation technique, in accordance with one aspect of the present disclosure;

FIG. 27 depicts modifying the recognition model for the WW to account for variable silence gap between words, in accordance with one aspect of the present disclosure;

FIG. 28 depicts a phoneme tokenizer that converts the graphemes in the input text “afternoon” into a string of phonemes, in accordance with one aspect of the present disclosure;

FIG. 29 depicts a block diagram of the training phase and the decoding phase of a tokenizer, in accordance with one aspect of the present disclosure;

FIG. 30 depicts a block diagram of the training phase of a tokenizer using a reference phonetic dictionary, in accordance with one aspect of the present disclosure;

FIG. 31 depicts sub-word splitting and the associated tags and positions of the sub-words for the word “Example” at different points, in accordance with one aspect of the present disclosure;

FIG. 32 depicts a phoneme-to-grapheme mapping for the word “Example” and the positions associated with the graphemes, in accordance with one aspect of the present disclosure;

FIG. 33 depicts a phonemes-to-sub-words assignment for the word “Example” for the sub-word splits of “Example” of FIG. 31 using the phoneme-to-grapheme mapping of FIG. 32, in accordance with one aspect of the present disclosure;

FIG. 34 depicts the tallied triplet {sub-word, tag, phoneme} and the probability of each triplet for all the words in the phonetic dictionary, in accordance with one aspect of the present disclosure;

FIG. 35 depicts a block diagram of the decoding phase of a tokenizer such as the tokenizer of FIG. 29 using the trained sub-word likelihoods dictionary, in accordance with one aspect of the present disclosure;

FIG. 36 depicts sub-word splits for the word “Infineon” of the WW “Okay Infineon,” in accordance with one aspect of the present disclosure;

FIG. 37 depicts a tabulation of the sub-word split combinations of the word “Infineon” of FIG. 36, the phonemes of the combinations, the corresponding probabilities of the phonemes of the combinations, and the phonetic probability for the sub-word split combinations, in accordance with one aspect of the present disclosure;

FIG. 38 depicts the operating details for tuning a text-to-speech engine to match the characteristics of the synthetic speech generated by the text-to-speech engine with those of real speech, in accordance with one aspect of the present disclosure;

FIG. 39 depicts a block diagram of the training or tuning of the data free speech recognition system using the tuned text-to-speech engine to synthesize speech that is otherwise unavailable to the speech recognition system, in accordance with one aspect of the present disclosure;

FIG. 40 depicts a block diagram of the analysis block of FIG. 39 used to analyze synthetic speech to compile statistics for aiding sequence decoding of target speech, in accordance with one aspect of the present disclosure;

FIG. 41A depicts the time plot for the phonemes of the WW “Okay Infineon,” in accordance with one aspect of the present disclosure;

FIG. 41B depicts the spectral plot for the phonemes of the WW “Okay Infineon,” in accordance with one aspect of the present disclosure;

FIG. 41C depicts the time boundaries determined by the aligner block 4010 for the phonemes of the WW “Okay Infineon,” in accordance with one aspect of the present disclosure;

FIG. 42 illustrates a flow diagram of a method 4200 for operating a data free speech recognition system, in accordance with one aspect of the present disclosure; and

FIG. 43 illustrates a block diagram of a device that implements a data free speech recognition system, in accordance with one aspect of the present disclosure.

### DETAILED DESCRIPTION

Examples of various aspects and variations of the subject technology are described herein and illustrated in the accompanying drawings. The following description is not intended to limit the invention to these embodiments, but rather to enable a person skilled in the art to make and use this invention.

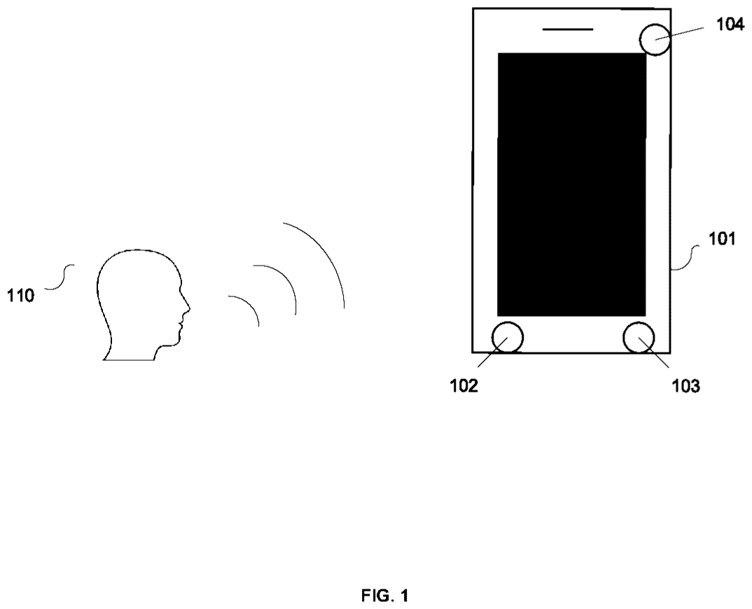

FIG. 1 depicts a scenario of a user uttering a voice command including a WW followed by a command to a smartphone for the smartphone to detect and to recognize the voice command, in accordance with one aspect of the present disclosure. The smartphone 101 may include three microphones 102, 103, and 104 located at various locations on the smartphone 101. The microphones 102, 103, and 104 may form a compact microphone array to capture speech signals from the user 110. As an example, the user 110 may utter a WW or phrase followed by the query “What time is it?” to request the current time from a smart assistant application. The target speech signals may be mixed with undesirable sound from the noisy environment. The smartphone 101 may divide the speech signals captured by the microphones into frames and may transmit the audio data frames to a speech recognition algorithm executing on the smartphone 101 or on a remote server.

Described are methods and systems for a WW and command recognition solution that does not require any user defined WW or command-matching speech data for training. This approach enables the user/customer to quickly and inexpensively deploy a speech recognition-based human-machine interface (HMI). The disclosed systems and methods enable a speech recognition solution trained based (e.g., solely) on text-specified WWs and commands to be deployed very quickly. The system is termed “data free speech recognition” because of the lack of needing speech data specific to the user-defined WWs and commands. Advantageously, the “data free” system may use, for example, text or grapheme representation of the WW or commands for online training on the order of seconds before the system is ready for use. The resulting low complexity and small memory footprint may be implemented on an edge processor while the system is robust enough to handle confusable phonemes, accents, different pronunciations and adverse environmental conditions.

A system architecture for continuous speech recognition may have a feature analysis module of the speech signal, followed by a unit matching block, lexical decoding block, syntactical analysis block, and a semantic analysis block to generate recognized utterance. The feature analysis block typically involves a spectral and/or temporal analysis of the speech signal yielding observation vectors, x, which are processed by the unit matching block to characterize various speech sounds. The unit matching block may include a recognition unit to recognize linguistically-based sub-word units such as phones, diphones, or triphones, partial or whole word units or even multiple word units. Generally, the smaller the sub-word unit, the fewer of them there are, but the more complicated their structure is in speech, and hence, the more reliant system performance hinges on the remaining architecture blocks.

The lexical decoding block applies word-based knowledge to the output of the recognition unit, putting restrictions on possible unit decoding by considering word structure. A word dictionary may be included to further restrict possibilities to the valid word database. In the case that the output of the recognition unit is words, the lexical decoding block may be eliminated. The syntactical analysis block applies further constraints based on word grammar and proper sequencing. Finally, semantic analysis block includes additional constraints based on meaning, reference, logic, implication, application, etc.

The continuous speech recognition architecture may be capable of handling a large vocabulary. Many applications exist where the valid vocabulary is very limited, often limited to the context of a single focused scenario, such as controlling the functions of an oven, or adjusting the settings of a smart thermostat. Often, the application includes a wake-word (WW) to address the device, followed by a limited and known set of commands. In one embodiment, the application may accept a command without a WW present (e.g., push to talk). For the case of the WW, the job at hand is to recognize a single word or phrase in an essentially infinite possible range of input speech, noise, and conditions. In this deployment scenario, the continuous speech recognition architecture may be simplified by eliminating the syntactical analysis block and the semantic analysis block. In further simplification, if the recognition unit is targeted to recognize the WW itself, then the lexical decoding block may be eliminated as well.

For speech recognition of commands, if the words contained within the set of commands are limited and the grammar is known and restricted to the set of commands, the syntactical analysis may generate the recognized commands, thus eliminating the semantic analysis. If the lexical decoding can construct complete commands rather than individual words, the syntactical analysis may be eliminated too. One or more of the feature analysis module, unit matching block, lexical decoding block, syntactical analysis block, and semantic analysis block may leverage neural networks and machine learning models, depending on the applications, resource requirements, performance requirements, hardware capabilities, available training data, etc., to generate a wide-range of speech recognition architecture customized to the tasks and resources at hand.

To accelerate the training and deployment of a neural network-based speech recognition architecture to recognize user-defined WWs and commands while offering robust performance, a “data-free” speech recognition architecture may receive text rather than speech data to build one or more command models during an online training phase. During the inference phase, the neural network-based speech recognition system may use the command models and an acoustic model (derived from offline training) to recognize speech as a command associated with the received text.

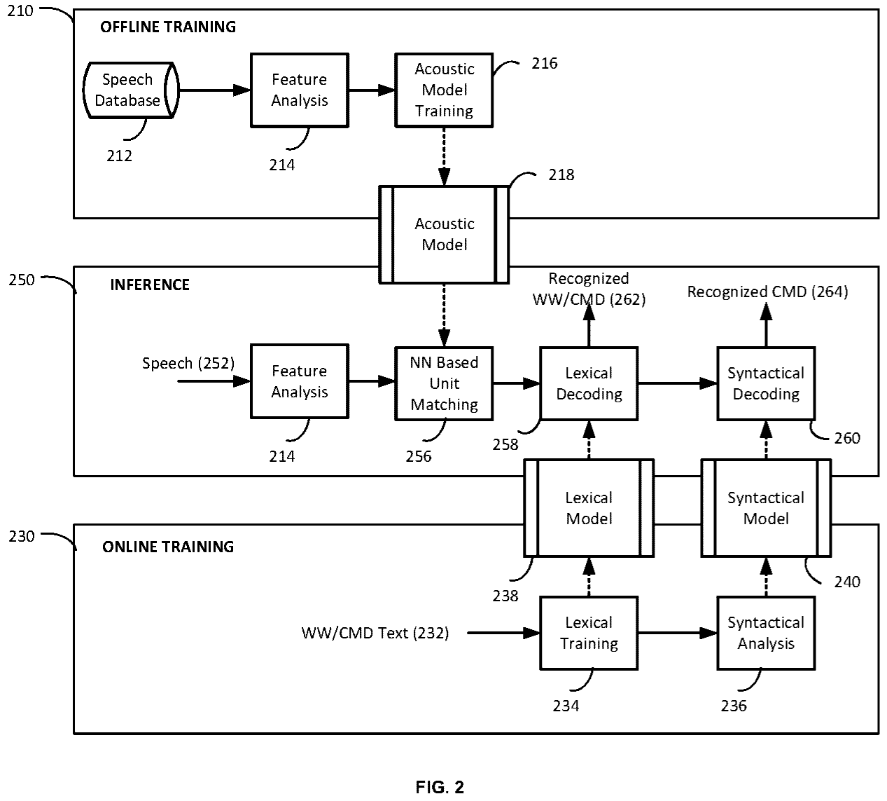

FIG. 2 depicts a high-level architecture of a data-free speech recognition system, in accordance with one aspect of the present disclosure. The training of the speech recognition architecture may be broken into two parts: offline training 210 and online training 230. The offline training 210 may use publicly available annotated speech databases 212 to train a neural network-based acoustic model 218 (e.g., neural network-based unit matching block 256) to recognize acoustic units (e.g., phonemes) during inference. The offline training 210 is performed once during system development and is independent of the user-defined WWs and commands (other than the language). In one embodiment, the offline training 210 may be independent of a particular language by training the acoustic model 218 to recognize acoustic units from any language. During the offline training phase 210, a feature analysis module 214 may perform spectral and/or temporal analysis of the speech signal from the annotated speech database 212 to yield vectors, which are processed by acoustic model training 216 to train the acoustic model 218.

On the other hand, the online training 230 may be performed using user-defined WWs and command texts 232 to build one or more command models such as a lexical decoding model 238 or a syntactical analysis model 240 for WW and command speech recognition during inference. In one embodiment, the online training 230 may train a text-to-speech (TTS) engine (not shown) to generate synthetic speech of the WWs and command texts 232 that is then used for lexical analysis training 234 of the lexical analysis model 238 and syntactical analysis training 236 of the syntactical analysis model 240. In one embodiment, the lexical analysis model 238 and/or the syntactical analysis model 240 may be based on a statistical model such as the Hidden Markov Model (HMM) phoneme-based word model.

During the inference stage 250, the data-free speech recognition architecture uses the one or more command models (e.g., lexical analysis model 238 and syntactical analysis model 240) from the online training and the acoustic model 128 from the offline training to recognize speech 252 uttered by a user as a WW 262 or a command 264 associated with the text. The inference stage 250 may use the same feature analysis module 214 used for the offline training 210 of the acoustic model 218. The feature analysis module 214 may perform spectral and/or temporal analysis of the speech 252 for processing by the neural network-based unit matching block 256 using the acoustic model 218. A sequence decoding block that includes lexical decoding 258 and syntactical decoding 260 may use the lexical model 238 and syntactical model, respectively, to process the output of the unit matching block 256 to recognize a WW 262 or command 264 from the set of user-defined WWs and command texts 232.

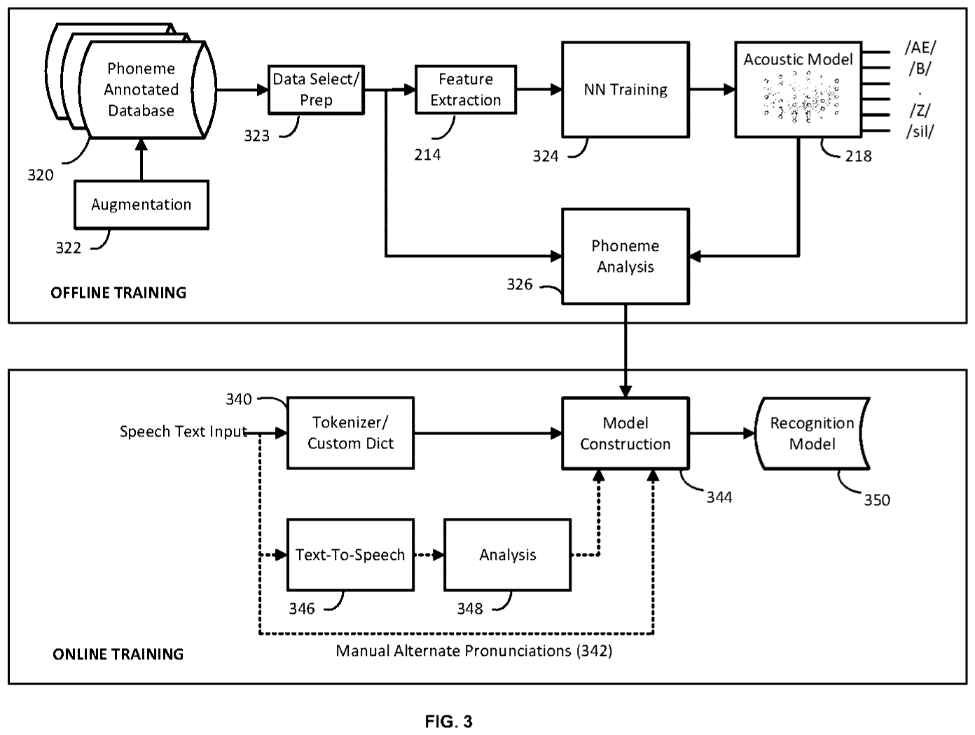

FIG. 3 depicts operational details of the offline training and online training of a data-free speech recognition architecture, in accordance with one aspect of the present disclosure.

The role of the offline training is to produce a neural network-based acoustic model 218 capable of identifying the acoustic units present in the input speech. The acoustic unit used by the system may be the phoneme. The neural network-based acoustic model is trained “offline” as it is independent of the target phrases (other than the language). In one embodiment, the offline training may produce a neural network-based acoustic model 218 capable of identifying acoustic units present in any language so that the data-free speech recognition architecture for many languages may use the same acoustic model. Target phrases as used here may refer to the WWs or commands that the data-free speech recognition system is trained to recognize. To achieve this, offline training may employ multiple speech databases. The databases may be annotated, such as phoneme annotated database 320, to identify the boundaries of the phonemes contained within the databases. The augmentation block 322 may augment the phoneme annotated databases 320 to further enrich the variety of content and improve training. The data select/prep module 323 may select the files for training based on the desired balance in terms of gender, native talkers, non-native talkers, accent, age, background noise, room acoustics, etc., and can be adjusted based on the envisioned target application (close talking, near field, far field, geographic location, background noise environment, etc.). The feature extraction block 214 performs a spectral and temporal analysis of the input speech from the selected file and produces observation vectors, also referred to as observation sequences, which capture the important recognition aspects and discards as much as possible the rest.

The neural network (NN) training block 324 iterates through the set of observation sequences and respective annotation information to learn to distinguish between and classify the input speech according to the specified acoustic units, in this case phonemes. The output of the neural network-based acoustic model 218 is a sequence of Softmax vectors consisting of the phonemes of the language plus a silence/noise class. In one embodiment, the output of the neural network-based acoustic model 218 is a frame-by-frame estimate of the likelihood or probability of the presence of the set of recognized units (phonemes in this case). In one embodiment, the output of the neural network-based acoustic model 218 represents some other estimate of the presence of the recognized units. This estimate may be limited in accuracy and precision and varies by different NN designs, training databases used, quality of the annotations, etc.

The phoneme analysis model 326 performs an analysis of the final acoustic model, captures relevant information, and incorporates this information into a decoding model. In one embodiment, the phoneme analysis block 326 collects statistical information characterizing the phonetic content and behavior of the databases and the trained acoustic model 218 that is later used to improve decoder model construction and performance.

The decoding model is trained or constructed “online” as it is dependent on the target phrase and is performed quickly for near immediate use by the user. The online training is based on the user-defined WWs and commands which are entered as text. In FIG. 3, the solid line may denote the normal path while the dotted line may denote optional paths. The user-defined text of the target phrases is input to the tokenizer/custom dictionary block 340, which includes a tokenizer and a custom dictionary that convert the text to its phoneme string equivalent, such as providing phoneme sequence corresponding to each target phrase. The conversion may be done by the tokenizer that converts any unseen text, while the custom dictionary allows a predefined phoneme specification for non-dictionary type words (e.g., “Infineon” as a WW) or alternate pronunciations that the tokenizer might otherwise not match. The tokenizer/custom dictionary block 340 may not only provide the preferred or most likely phoneme sequence, but may also provide alternative sequences that model different pronunciations or accents. In one embodiment, a user may manually enter the desired, preferred, and/or alternate pronunciations 342 or phoneme sequence. From the phoneme sequence of the target WWs and commands, along with the results of the phoneme analysis 326 from the offline training, the model construction block 344 generates the recognition model 350 that is used during inference. In one embodiment, for improved performance, the model construction block 344 may optionally utilize text-to-speech 346 to generate synthetic data containing the target WWs and commands. An analysis module 348 may analyze the synthetic data to aid the model construction block 344 when generating the recognition model 350.

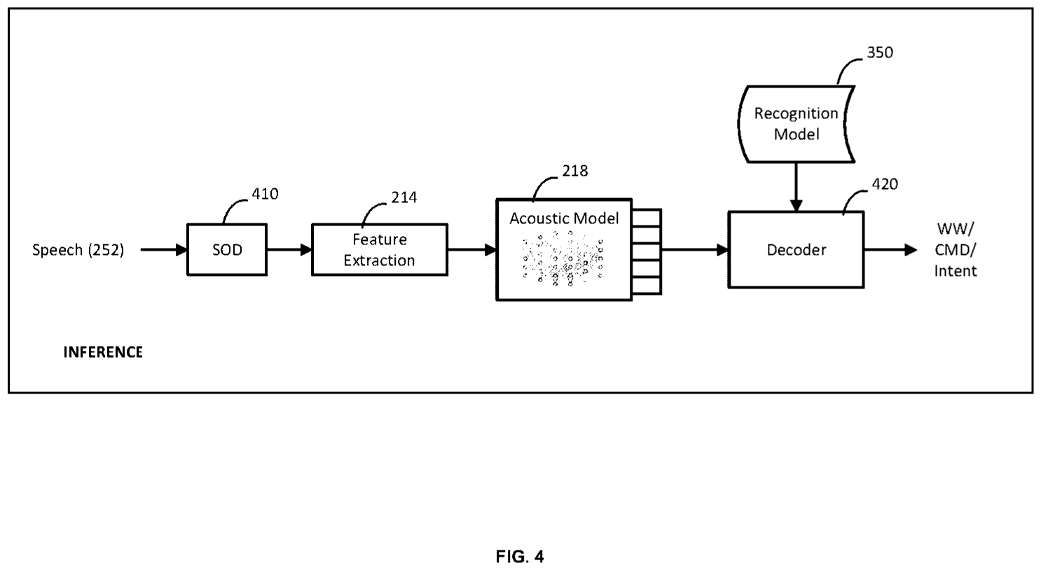

FIG. 4 depicts processing details of the inference stage of a data-free speech recognition architecture using the trained acoustic unit 216 from the offline training and the recognition model 350 from the online training, in accordance with one aspect of the present disclosure. The input speech 252 is first processed by a speech onset detection algorithm (SOD) module 410. Because the user first addresses the device with a WW, there is an assumption of a preceding pause, as a person would naturally do when addressing another person. The SOD module 410 is designed to trigger on a speech onset that is preceded by a minimum amount of non-speech. The inclusion of the SOD function provides multiple advantages to the system performance: (1) the subsequent operational blocks may be gated during non-speech passages, thus significantly reducing processing load and power consumption; and (2) during continuous speech, the SOD will only trigger where the preceding non-speech gap is observed, thus blocking a significant amount of audio from being processed and potentially causing false detections. The feature extraction block 214 performs a spectral and temporal analysis of the input speech 252 during active speech to produce observation vectors that are consumed by the acoustic model (AM) 218. The acoustic model 218 utilizes the NN based unit matching model 256 obtained from offline training and outputs a series of Softmax vectors from the time series of input observation vectors. The decoder block 420 takes in the series of Softmax vectors and applies statistical modeling according to the recognition model 350 to determine if the WW is present, or which command from a set of user-defined commands was spoken.

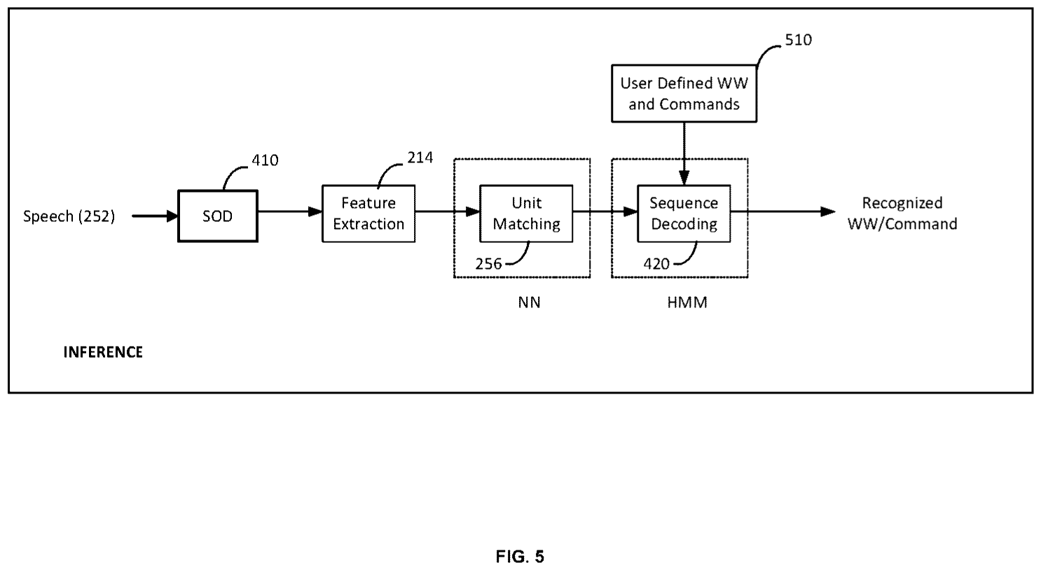

FIG. 5 depicts another view of the inference stage of a data-free speech recognition architecture, in accordance with one aspect of the present disclosure. The NN-based unit matching block 256 is part of the trained acoustic unit 216 obtained from the offline training. The user-defined WW and commands 510 are the target phrases whose phonemes are in the recognition model 350 obtained from the online training, The feature extraction block 214 extracts pertinent features from the input speech on a frame-by-frame basis, where a frame is a unit of time for operating the NN-based unit-matching block 256. The feature extraction block 214 feeds the extracted features to the NN-based unit matching block 256. The NN-based unit matching block 256 processes the extracted features to output a sequence of unit (phoneme) likelihood vectors every frame. The sequence decoding block 420 may incorporate a hidden Markov Model (HMM) based on the text-based user-defined WW and commands 510 to render the recognized phrase.

As discussed, the NN-based unit matching block 256 is trained offline using annotated databases to learn to discriminate between the units (phonemes). The HMM models for sequence decoding 420 are based on the user defined text input descriptions of the desired set of WWs and commands (e.g., target phrases). Since the system is data-free, material containing the target phrases is not available during the offline training process. The data-free speech recognition architecture utilizes the training procedure as discussed in FIG. 3 to achieve a highly accurate, robust, decoding approach that is adaptive to the final NN acoustic model 218, and to alternate pronunciations of the target phrases. In one aspect, the HMM models for sequence decoding 420 may incorporate the alternate pronunciation information modeled by the recognition model 350 constructed from the online training. As discussed in FIG. 3, the results of the phoneme analysis of the NN-based unit matching block 256 performed by the phoneme analysis block 326 as part of the offline training of the acoustic model 218 may also be used to construct the recognition model 350.

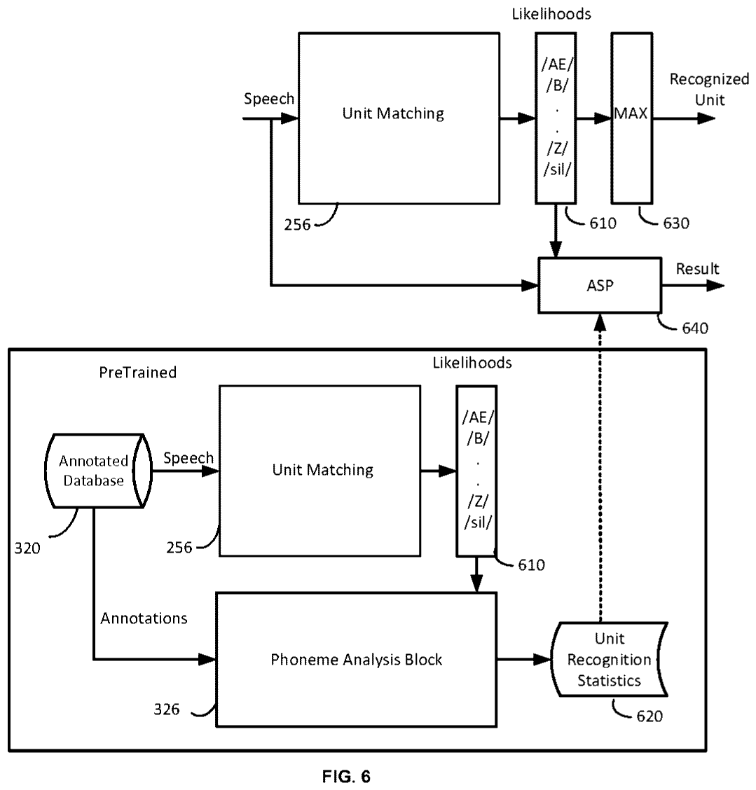

FIG. 6 depicts the use of the phoneme analysis block 326 to generate statistics based on the phonemes output by the unit matching block 256 to generate statistics to improve the decoding of the recognize phrase in automatic speech processing (ASP) applications, in accordance with one aspect of the present disclosure.

The annotated database 320 includes labeling of the true units and their respective time boundaries within the training speech clips. During offline training of the acoustic model 218, the unit matching block 256 processes through the annotated database while simultaneously the phoneme analysis block 326 collects and compiles information on how the likelihood results 610 relate to the true labeled units within their respective time boundaries. For example, the phoneme analysis block 326 collects statistical information characterizing the phonetic content and behavior of the annotated databases 320 and the unit matching block 256. The phoneme analysis block 326 compiles the phoneme analysis block 326 statistical information into a unit recognition statistics database 620. The ASP 640 then uses the unit recognition statistics database 620 to improve its results when utilizing the unit matching bock 256 block on unseen speech data. In one embodiment, the phoneme analysis block 326 generates a matrix of statistics characterizing the unit matching block 256 of the acoustic model 218.

In one aspect, the recognition model 350 uses the matrix of statistics to aid the ASP 640 such as the sequence decoding block 420 incorporating the HMM of FIG. 5 to render the phrase from the text-based user-defined WW and commands 510. In one aspect, the unit matching block 256 may use the matrix of statistics to modify the likelihood results 610 (e.g., Softmax values). A maximum likelihood block 630 may find the maximum of the modified likelihood results as the recognized unit (phoneme).

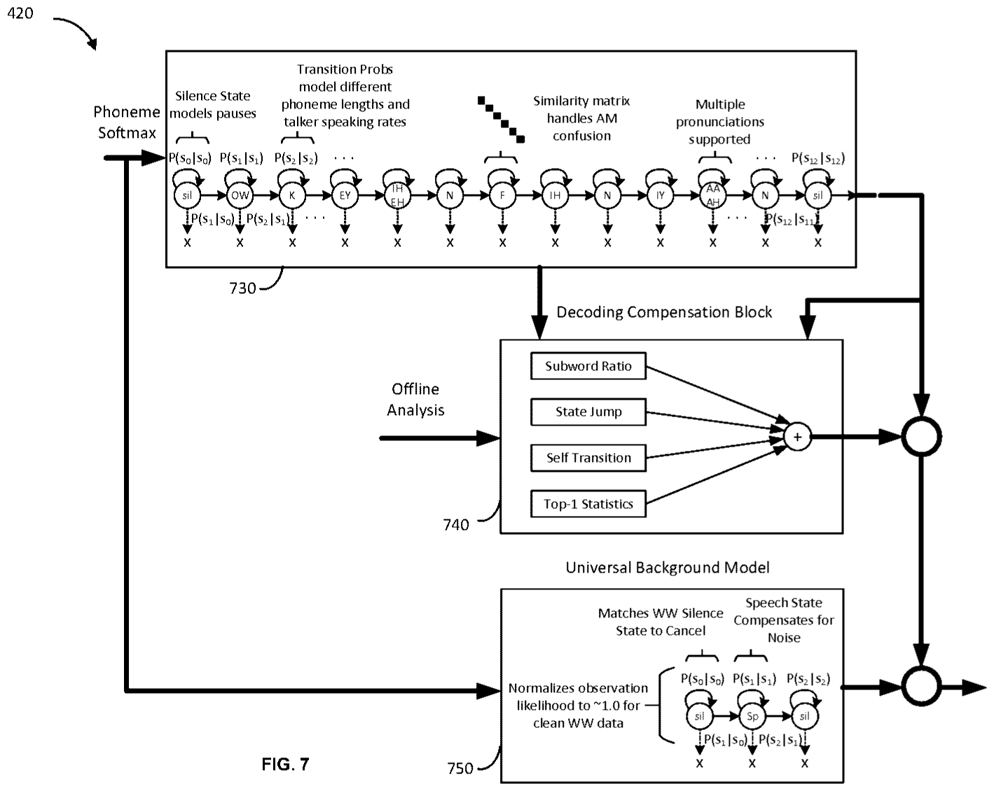

FIG. 7 depicts a block diagram of the sequence decoding block 420 incorporating the HMM, in accordance with one aspect of the present disclosure. The HMM (shown as word/command model 730) is a technique for statistical modeling of real-word processes such as speech signals, in accordance with one aspect of the present disclosure. When applied to phoneme-based speech detection, each state in the HMM is made to represent a phoneme. The beginning and ending states are modeled by silence, while the internal states represent the constituent phonemes of the word or command. The observations of the model, the Softmax output probabilities of each phoneme, is a probabilistic function of the state. As a result, the HMM is a doubly embedded stochastic process with an underlying stochastic process that is not observable (it is hidden), but can only be observed through another set of stochastic processes that produce the sequence of observations. In one embodiment, the self-transition probability, P(sᵢ|sᵢ), is computed according to the expected length of the phoneme of state i.

The HMM evaluates the probability of the sequence of observations at each input vector of Softmax values given a model of the HMM. The HMM may evaluate the probability by forward or Viterbi algorithm. The assignment of the phoneme to each state of the HMM is challenging and may use approaches such as phonetic dictionary, manual definition, a tokenizer, etc. However, the resulting phonetic transcription may not be a good match, especially for unseen words. In addition, these approaches do not generally yield alternative pronunciations. In one aspect of the present disclosure, a decoding compensation model incorporates features derived from internal behavior of the HMM and offline analysis of matching and non-matching words to improve the discrimination ability of the HMM.

Given the observation sequence X=x₁, x₂, . . . , x_{T}, and a model λ=(A, B, π), the HMM evaluates the probability of the observation sequence, P(X|λ), given the model λ (i.e., probability of the observation sequence X=x₁, x₂, . . . , x_{T} given the model λ of the HMM).

The word/command model 730 shows an example for using a HMM to modeling the WW “Okay Infineon” with the pronunciation/OW/K/EY/IH/N/F/IH/N/IY/AA/N/. However, alternate pronunciations may be equally valid or common, and is supported. The word/command model 730 may support alternate pronunciations by allowing multiple phonemes in each state definition of the HMM. The preferred or most common phoneme for each state may be listed first and used to derive the expected length (time) of the state. The WW “Okay Infineon” with multiple pronunciations is shown.

The value of the Softmax output corresponding to the j^{th} phoneme, phⱼ, is an estimate of the posterior probability P(q=phⱼ|x) where x is the observed input feature vector. Ideally, the acoustic model such as the unit matching block 256 would have 100% accuracy and be 100% confident (true phoneme Softmax score is 1.0). However, this is not the case. In fact, in clean conditions, the true phoneme has been shown to have the maximum score in the Softmax vector about 70-80% of the time with an average value of 0.5-0.9.

The Softmax output contains a posterior probability estimate for all phonemes, phⱼ, j=1 . . . N where N is the number of phonemes (plus noise) and has the property of:

$${\sum }_{j = 1}^{N} P ( q = {ph}_{j} \vert x ) = 1. \qquad ( Equation 1 )$$

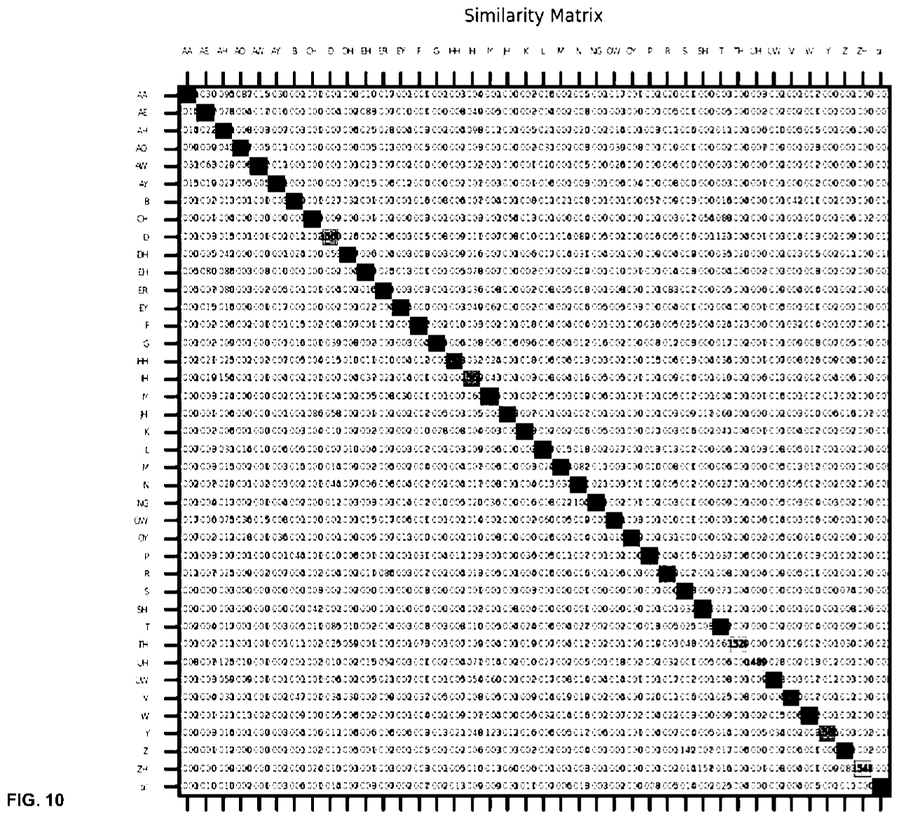

on a frame by frame basis. Hence, when the Softmax value of the true phoneme is less than 1.0, the difference is contained in the next most likely phonemes. Accordingly, a matrix can be built to capture this information to better characterize the acoustic model Softmax output. As indicated, the phoneme analysis block 326 of FIG. 6 may compile the matrix by processing through the annotated training database 320. The annotated training database 320 may indicate the true phoneme and the time boundaries of the phonemes within each audio file. For each phoneme time boundary, the phoneme analysis block 326 identifies and stores the Softmax vector of the frame containing the maximum value of the true phoneme. The phoneme analysis block 326 repeats this process for each utterance in the database such that a matrix of Softmax vectors is accumulated for each phoneme. The Softmax vectors are averaged across time to obtain the average Softmax vector values when the true phoneme is at its maximum value within the identified boundaries. FIG. 10 shows the an example of the matrix for the 40 phonemes used in American English plus silence class for characterizing the Softmax output of an acoustic model. The matrix is termed the “similarity matrix” since the posterior probabilities correlate with acoustically similar phonemes. The word/command model 730 solves the problem that given the observation sequence X=x₁, x₂, . . . , x_{T}, and a model λ of the HMM, what is the probability of the observation sequence, P(X|λ). The word/command model 730 may use the similarity matrix to determine the confusable phonemes in each state and to improve the performance of the model.

The word/command model 730 also includes a decoding compensation block 740 and a universal background model 750. The decoding compensation block 740 takes as its input the offline analysis from the phoneme analysis block 326, intermediate model observations and probabilities from the word/command model 730, and the current model probability, P(Xₙ|λ) to compute a new frame-by-frame model score that is used to detect the presence of the user-defined WW or commands. The decoding compensation block 740 incorporates not only P(Xₙ|λ) but also features derived from internal behavior of the word/command model 730, and additionally considers offline analysis of matching words (positive input) and non-matching words (negative input) from the phoneme analysis block 326 to improve the discrimination ability of the sequence decoding block 420 compared with P(Xₙ|λ).

To further improve the robustness of the sequence decoding block 420 to poorly articulated speech, noisy conditions, different speaker rates, etc., the universal background model (UBM) 750 attempts to normalize these conditions in estimating the user-defined WW or commands.

In one embodiment, the UBM 750 is modeled as a 3-state HMM of a leading silence state (leading sil), a speech state (Sp), and a final silence state (final sil). An HMM may be modeled by the transition probabilities of the states and the emission probabilities of the states. The transition probability of a state indicates how likely the HMM is to transition to the state given some current state. The emission probability of a state indicates the probability of the HMM generating an observation given some current state. The 3-state HMM may obtain an emission probability for the leading silence state from the NN Softmax entry for SIL, while the emission prob for the speech state is 1−(emission probability for leading silence state). The transition probability for the leading silence state may be based on the expected length of leading silence from when the SOD triggers until the start of the speech. The transition probability of the speech state may be based on the average length of the phonemes in the WW/CMD for which this UBM is working with. The self-transition probability of the final silence state may be 1.0. The probably of the UBM may be the maximum probabilities of these three states. The following describes in details operations of the sequence decoding block 420.

As discussed, the phoneme analysis block 326 of FIG. 6 may compile the similarity matrix by processing through the annotated training database 320 that contains the root-truth phonemes and the time boundaries of the phonemes within each audio file.

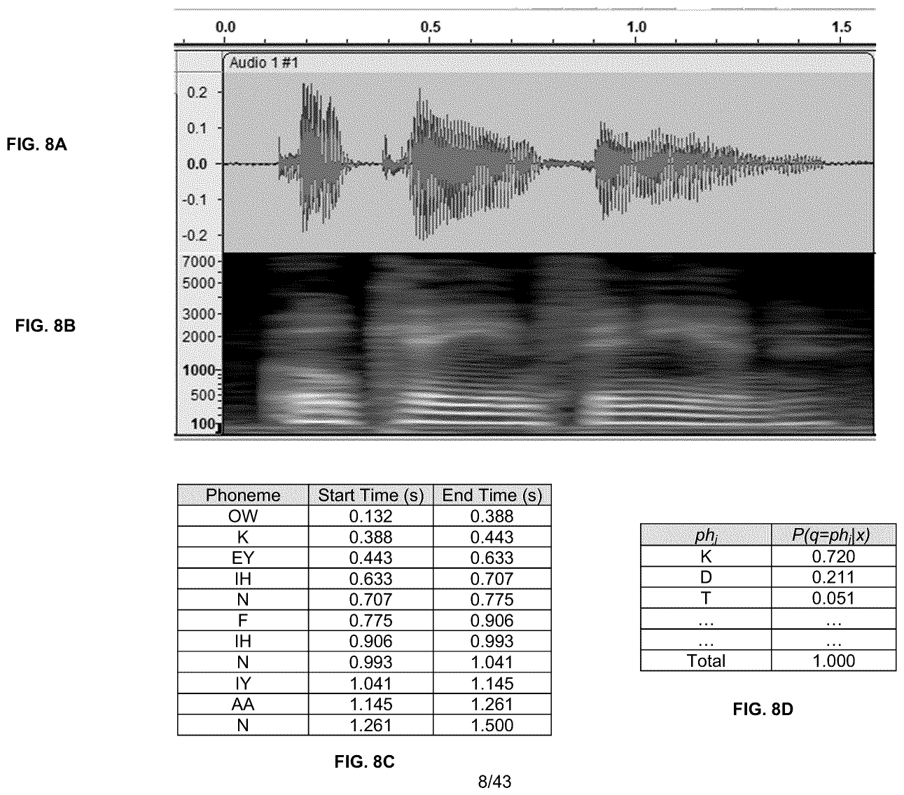

FIG. 8A shows the time plot for the phonemes of the WW “Okay Infineon,” in accordance with one aspect of the present disclosure. FIG. 8B shows the spectral plot for the phonemes of the WW “Okay Infineon,” in accordance with one aspect of the present disclosure. FIG. 8C shows the annotations of the phonemes and the start times and end times for each phoneme in the WW “Okay Infineon,” in accordance with one aspect of the present disclosure.

The unit matching block 256 of FIG. 6 (or the feature extraction block 214 of FIG. 5) may compute features based on the input speech from the annotated training database 320. The unit matching block 256 (also referred to as the acoustic model or AM) then performs a features-to-phoneme mapping. The output of the AM is a measure of the confidence in the presence of each phoneme in the current analysis window of speech. Some common confidence measures include the likelihood, such as the Softmax. It is assumed that the output corresponding to the j^{th} phoneme, phⱼ, is an estimate of the posterior probability P(q=phⱼ|x) where x is the observed input feature vector. Because the AM cannot be 100% confident in the features-to-phoneme mapping, the posterior probability P(q=phⱼ|x) for each root-truth phoneme is less than 1.

FIG. 8D shows an example of the P(q=phⱼ|x) output from the AM for the WW “Okay Infineon” at 0.41 s, in accordance with one aspect of the present disclosure. At 0.41 s, the analysis window is centered on the root-truth phoneme ‘K’ according to the annotations of FIG. 8C. FIG. 8D shows that the AM hypothesizes the most likely phoneme is ‘K’ with a posterior probability P=0.720, while the next most likely phonemes are ‘D’ and ‘T’. The sum total of the posterior probability is shown to be 1.000. Thus, the AM hypothesizes that the root-truth phoneme ‘K’ has the highest posterior probability, but the score is <<1.0 and the difference is predominantly in the similar sounding phonemes ‘D’ and ‘T’. If such behavior is consistent, such information can be used to further increase the confidence that ‘K’ is present. It follows then that using an annotated database with labeled root-truth phonemes and time boundaries, data as in FIG. 8D can be obtained for all instances of each phoneme (or unit).

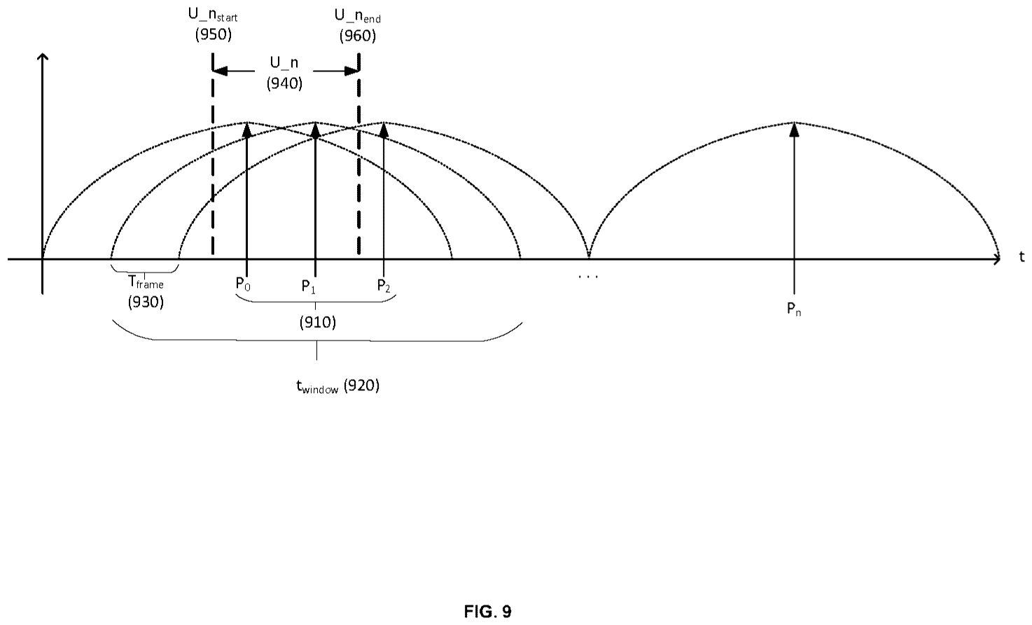

FIG. 9 depicts an example of the computation of posterior probabilities P(q=phⱼ|x) grouped by unit boundaries, in accordance with one aspect of the present disclosure.

The AM may compute the posterior probabilities, Pₙ (910), using data within a window of length t_{window} (920), which is shifted every analysis interval by t_{frame} (930). The center of each window represents the time instance for the respective Pₙ. For unit U_n (940), the start and end times are labeled U_nₛₜₐᵣₜ (950) and U_n_{end} (960), respectively. The posterior probabilities P₀ and P₁ lie within the time boundaries of U_n and are collected as part of the data for it, while P₂ lies outside of the boundary, using data within a window of length t_{window} (920), which is shifted every analysis interval by t_{frame} (930). The phoneme analysis block 326 of FIG. 6 may collect the posterior probabilities Pₙ (910) within the time boundaries of U_n (940) for the phonemes from the AM to compute desired statistics such as the unit recognition statistics 620 that can further improve either the unit (phoneme) recognition performance directly, or the downstream performance of the ASP results.

In one aspect, the phoneme analysis block 326 may build a matrix to capture this information and better characterize the AM output. For example, the phoneme analysis block 326 may compile a matrix by processing through the annotated training database 320. For each phoneme time boundary U_n (940), the posterior probabilities vector, Pₙ (910), of the frame (e.g., t_{window} (920)) containing the maximum value of the root truth unit (phoneme) is identified and stored. The phoneme analysis block 326 repeats this process for each utterance in the database such that a matrix of Pₙ (910) values is accumulated for each unit. The vectors are averaged across time to obtain the average Pₙ vector values when the root-truth unit is at its maximum value within the identified boundaries.

FIG. 10 shows the matrix for the 40 phonemes used in American English plus silence class for one AM, in accordance with one aspect of the present disclosure. The matrix is termed the “similarity matrix” since the posterior probabilities correlate with acoustically similar phonemes. The matrix shows the root-truth units on the x-axis and the AM output values on the y-axis.

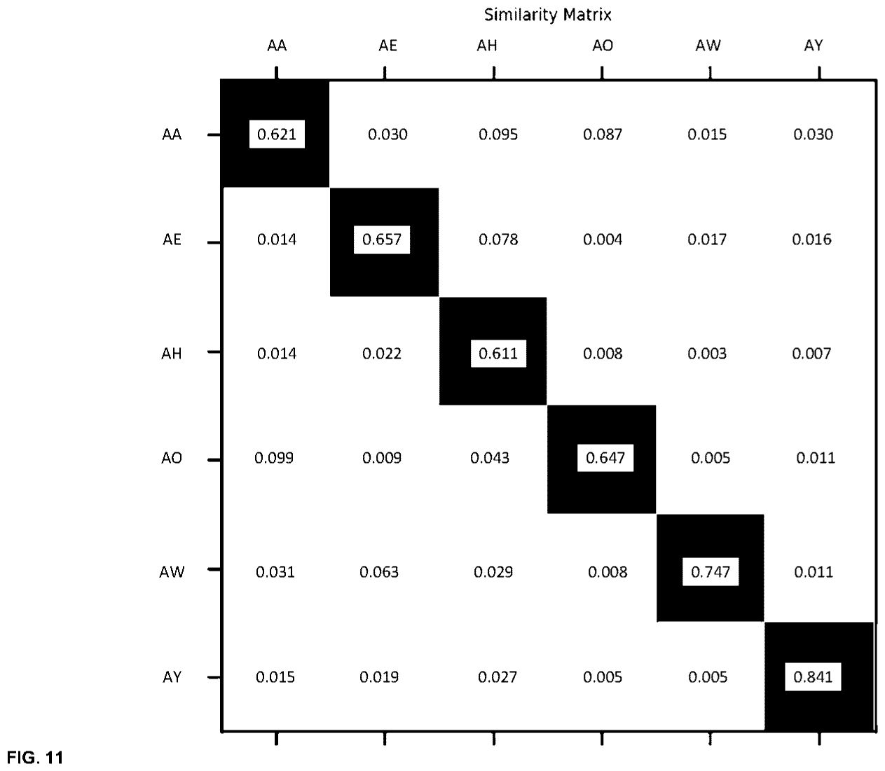

FIG. 11 shows a magnified view of the top left portion of the matrix of FIG. 10, in accordance with one aspect of the present disclosure. The first column indicates that when the root-truth phoneme is ‘AA’, the AM outputs an average maximum Pₙ value for ‘AA’ of 0.621. At the same time, the average values for the phonemes {‘AE’, ‘AH’, ‘AO’, ‘AW’, ‘AY’} are {0.014, 0.014, 0.099, 0.031, 0.015}, respectively.

As explained above, the AM is neither 100% accurate nor 100% confident in classifying the phonemes. The output classes sum to one as shown in Equation (1). Hence, when the Softmax value of the true phoneme is less than 1.0, the difference is contained in the next most likely phonemes. The similarity matrix captures statistics of this confusion across similar phonemes. In one aspect, to improve the discrimination ability of the AM, the unit matching block 256 incorporates the a priori information in the similarity matrix into the posterior probability estimates.

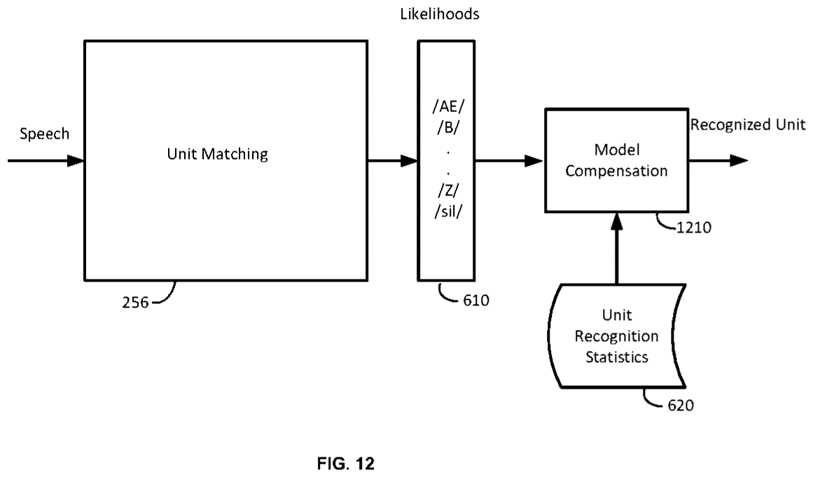

FIG. 12 depicts the unit matching block 256 modifying the posterior probabilities according to the computed statistics in the similarity matrix, in accordance with one aspect of the present disclosure.

The posterior probability that the current phoneme, q, is the j^{th} phoneme, phⱼ is given by the equation:

$$P ( q = p {h}_{j} \vert x ) = Sx ( j ) \qquad ( Equation 2 )$$

where Sx(j) is the Softmax value of the j^{th} phoneme in the j^{th} row. The similarity matrix gives the average value of each phoneme, phᵢ, when q=phⱼ and phⱼ is at its maximum value. For example, referring to the magnified similarity matrix in FIG. 11, the first column gives the average Softmax scores when q=‘AA’ with the top 3 scores {‘AA’=0.621, ‘AO’=0.099, ‘AW’=0.031}. Hence, if such scores were actually observed, the unit matching block 256 would have increased confidence that q=‘AA’. One way to quantify this would then be to identify the most likely phonemes and sum them. This would work for the above scenario but likely performs poorly for {‘AA’=0.1, ‘AH’=0.6, ‘AO’=0.2}. In this case, the posterior probability estimates do not correlate well with those in the similarity matrix.

To address this, one technique to improve the posterior probability estimates is to add the Softmax values of the confusing phonemes with restrictions in consideration of the ratios in the similarity matrix. Denote the top-N highest scores in the j^{th} column of the similarity matrix, Simⱼ, to be {phₖ₁, phₖ₂, . . . , ph_{kN}}, then a new posterior probability estimate, Pₛᵢₘ, is formulated to be:

$${P}_{s i m} ( q = p {h}_{j} \vert x ) = S {x}_{j} ( k 1 ) + {\sum }_{k = k 2}^{k N} min ( ( \frac{S i {m}_{j} ( k )}{S i {m}_{j} ( k 1 )} + {Δ}_{R} ) * S x ( k 1 ) , Sx ( k ) ) \qquad ( Equation 3 )$$

where Δ_{R} is a small factor (e.g., Δ_{R}=0.1) added to the ratio of

$$\frac{S i {m}_{j} ( k )}{S i {m}_{j} ( k 1 )}$$

to allow some variance, as the ratios were the global average. The model compensation block 1210 modifies the likelihood results 610 (e.g., Softmax outputs) as in Equation 3 to improve the posterior probability estimates only when the Softmax outputs correlate well with the similarity matrix, thus improving recognition ability without increasing false detections.

Advantageously, the approach to modify the posterior probabilities according to the computed statistics in the similarity matrix improves phonetic modeling for a given acoustic model, thereby improving phoneme recognition and speech recognition. In addition, the acoustic model training loop may integrate the model compensation block 1210 to automatically compensate for different AM characteristics, thus avoiding the need to retrain or retune the ASP system.

In one aspect, the HMM used for decoding the posterior probability sequence for speech recognition may use Equation 3 to improve the transition probabilities for the state decoding.

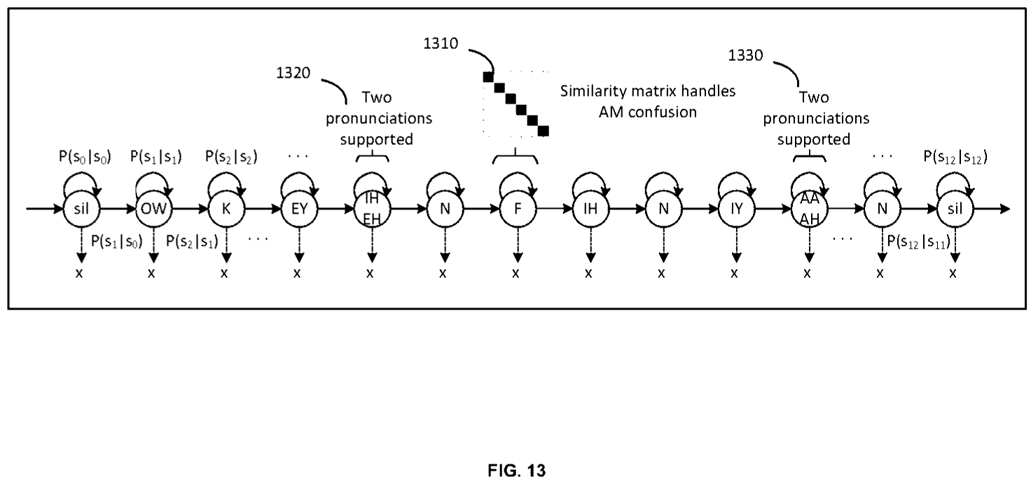

FIG. 13 shows a HMM of a sequence decoding model for recognizing WWs or commands according to the computed statistics in the similarity matrix, in accordance with one aspect of the present disclosure.

The j^{th} state in the HMM represents the j^{th} phoneme in the WW or command being recognized. The model begins and ends with a silence state, and the total number of states in the model is Nₛₜₐₜₑₛ. FIG. 13 shows the WW “Okay Infineon” with phoneme transcription/OW/K/EY/IH/N/F/IH/N/IY/AA/N/. The HMM uses the similarity matrix 1310 to handle confusing phonemes. In one embodiment, the HMM may not contain explicitly a silence state when the silence state is combined with another state that models a phoneme.

In one aspect, alternate pronunciations may be equally valid or common. The HMM may support alternate pronunciations by allowing multiple phonemes in each state definition, as shown for states 1320 and 1330. The preferred or most common phoneme for each state may be listed first and used to derive the expected length (time) of the state. The HMM may limit the number of pronunciations to minimize processing complexity. In addition, the alternative pronunciations increase the chance for false detections, so this may be weighed against the improvement in detection rate.

When determining the pronunciations to be included in the HMM, the model may include probabilities. For example, if two pronunciations are equally probable, then the HMM may include both pronunciations. However, if one pronunciation has probability of 0.99 while the other 0.01, then the HMM may not include the latter pronunciation, as its inclusion will only slightly improve the positive recognition rate, while likely increasing the false detection rate by a disproportionate amount.

In one aspect, a tokenizer such as the tokenizer/custom dictionary block 340 of FIG. 3 used to convert text into its phoneme string equivalent may identify multiple pronunciations of a word to be modeled. For example, the custom dictionary block 340 may provide not only the preferred or most likely phoneme sequence, but may also provide alternative sequences and the probabilities of each phoneme sequence. In addition, an advanced user with phonetic knowledge may provide preferred and alternative pronunciations, especially for a WW that is not in the dictionary (e.g., “Okay Infineon”).

In one aspect, the HMM of a sequence decoding model contains the primary pronunciation phoneme for each state, along with up to P−1 alternate pronunciations for each state, for a total of up to P phones for each state. For each pronunciation, the highest confusing phonemes according to the similarity matrix may be included along with their respective ratios according to Equation 3. In one embodiment, confusable phonemes are included until the sum of Equation 4:

$${\sum }_{k = k 2}^{k N} ( ( \frac{S i {m}_{j} ( k )}{S i {m}_{j} ( k 1 )} + {Δ}_{R} ) ) \qquad ( Equation 4 )$$

is greater than 0.8 and Sim; (k)>0.05 and kN≤4. These parameters are configurable.

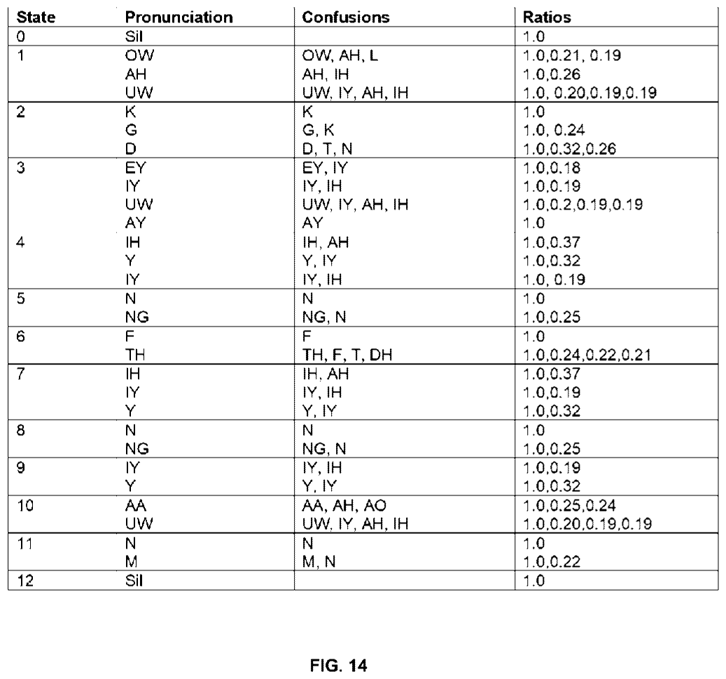

FIG. 14 shows an example of the possible pronunciations and the highest confusing phonemes of each pronunciation for states in the HMM for “Okay Infineon,” in accordance with one aspect of the present disclosure. The ratios in the table of FIG. 14 for the highest confusing phonemes of each pronunciation include AR of Equation 4.

As discussed in FIG. 7, the sequence decoding block 420 may include a decoding compensation block 740 and a universal background model 750. The decoding compensation block 740 takes as its input the offline analysis from the phoneme analysis block 326, intermediate model observations and probabilities from the HMM of the word/command model 730, and the current model probability, P(Xₙ|λ) to compute a new frame-by-frame model score that is used to improve the discrimination ability of the sequence decoding block 420.

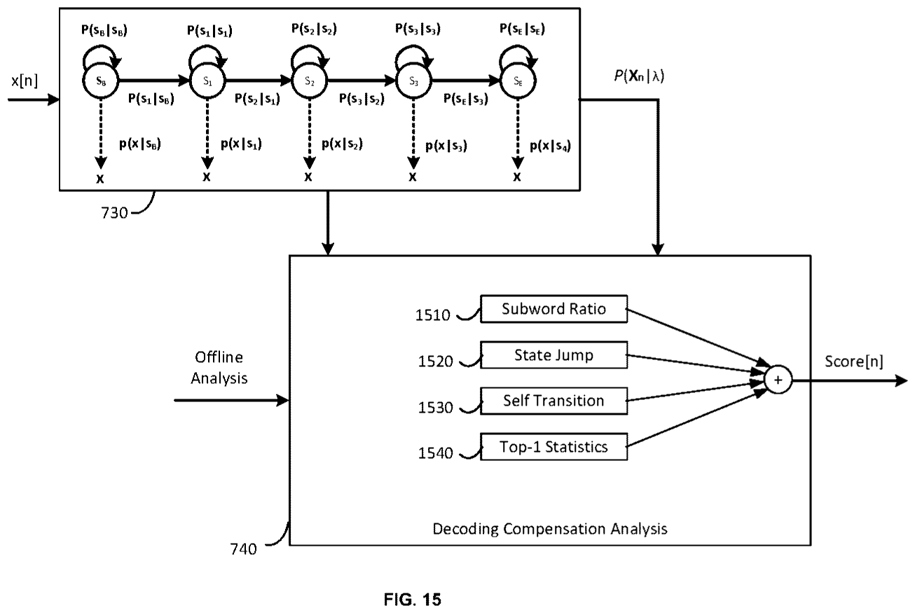

FIG. 15 depicts the use of the decoding compensation block 740 to improve the sequence decoding of the WWs or commands from the HMM of the word/command model 730, in accordance with one aspect of the present disclosure.

In one aspect, the HMM may be determined by parameters λ=(A, B, π), where A represents the transition probability matrix of the states, B represents the emission probability; and π represents the initial state distribution. A is a matrix whose rows represent a probability distribution that dictates how likely the HMM is to transition to each state, given some current state. B estimates the probability of the HMM generating an observation X=(x₁, x₂, . . . , x_{T},), given some current state. π is a probability distribution that dictates the probability of the HMM starting in each state (usually start in first state).

For example, in the HMM of the word/command model 730 of FIG. 15, the transition probabilities, P(sⱼ|sₖ), are defined by the matrix, A, as described above. The probability of the observation vector, x, at a given state, sⱼ is given by the output distribution based on the emission probability B:

$${b}_{j} ( x ) = p ( x \vert s = j ) \qquad ( Equation 5 )$$

Given the observation sequence X=x₁, x₂, . . . , x_{T}, and a model λ=(A, B, π), the HMM evaluates the probability of the observation sequence, P(X|λ), given the model λ (i.e., probability of the observation sequence X=x₁, x₂, . . . , x_{T} given the model λ of the HMM). A straightforward approach to evaluate (X|λ) may sum over all possible state sequences s₁, s₂, . . . , s_{T} that could result in the observation sequence, X. However, this direct computation method is extremely complex.

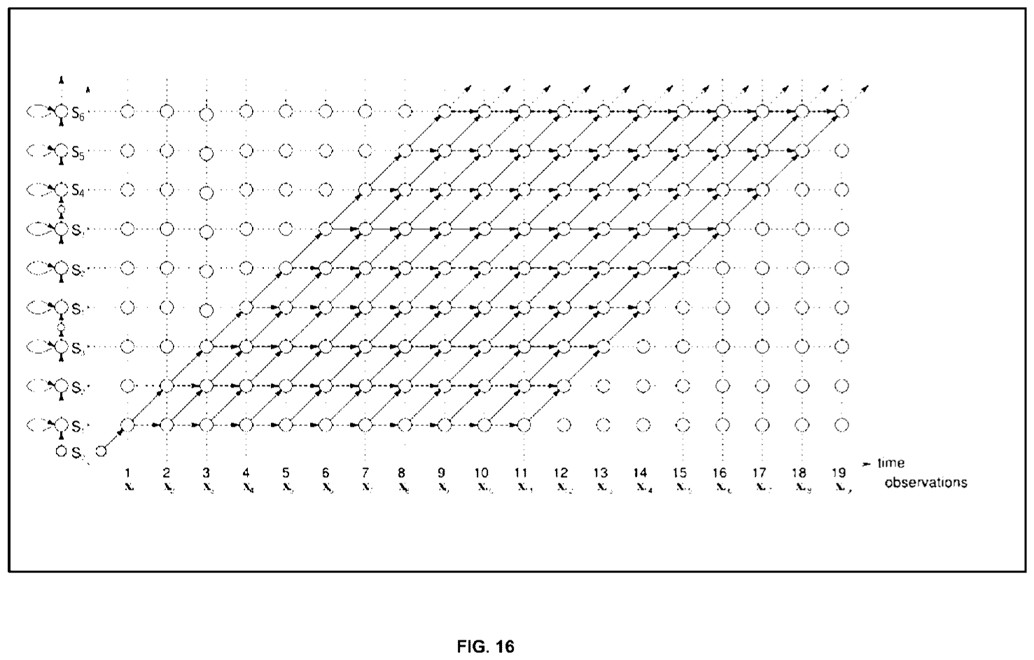

FIG. 16 shows a direct computation of P(X|λ), where the x-axis shows the observation sequence X in time and the y-axis shows the states, in accordance with one aspect of the present disclosure. The arrows show the possible state transitions or state sequences that may yield the observation sequence X. FIG. 16 shows that this computation is very complex.

Instead, the HMM may evaluate P(X|λ) using a recursive approach, known as the forward algorithm, based on the Markov assumption of the HMM.

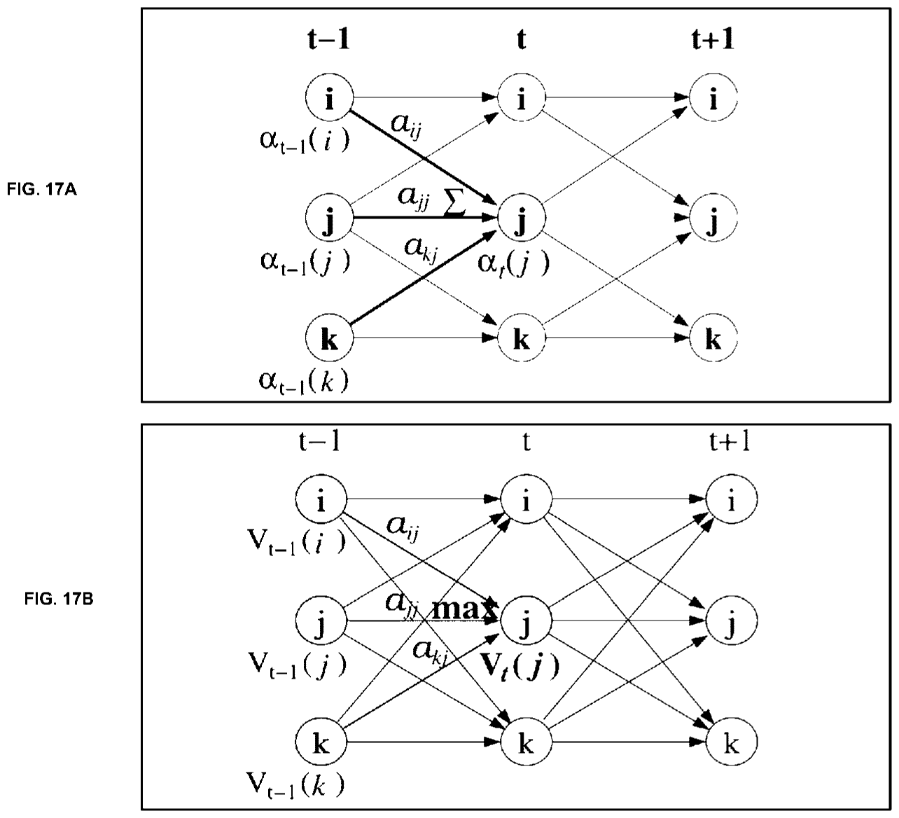

FIG. 17A depicts using the forward algorithm to evaluate P(X|λ), in accordance with one aspect of the present disclosure. The forward algorithm exploits the principle that since there are only N states (nodes at each time slot in the lattice), all the possible state sequences will re-merge into these N nodes, no matter how long the observation sequence. Then at each time, t, only the values αₜ(j), 1≤j≤N, are evaluated, where each calculation involves only N previous values of αₜ₋₁(j). For example, FIG. 17A shows that the forward algorithm evaluates αₜ(j) as a summation of the αₜ₋₁(i), αₜ₋₁(j), αₜ₋₁(k), weighed by their respective transition probabilities αᵢⱼ, αⱼⱼ, αₖⱼ.

In one embodiment, the HMM may use the Viterbi algorithm to further simplify the recursive approach by considering only the most likely path, instead of a summation.

FIG. 17B depicts the using Viterbi algorithm to evaluate P(X|λ), in accordance with one aspect of the present disclosure. The Viterbi algorithm yields the likelihood of the most probable path through the trellis. At each time t and state s, evaluation of P(X|λ) results in the computation of likelihood p(x|q=phⱼ).

The value of the Softmax output corresponding to the j^{th} phoneme, phⱼ, is an estimate of the posterior probability P(q=phⱼ|x). Using Bayes Rule, the posterior probability P(q=phⱼ|x) may be related to the likelihood p(x|q=phⱼ) by:

$$P ( q = p {h}_{j} \vert x ) = p ( x \vert q = p {h}_{j} ) \cdot P ( q = p {h}_{j} ) / p ( x ) \qquad ( Equation 6 )$$

Rearranging in terms of the likelihood yields:

$$p ( x \vert q = p {h}_{j} ) = \frac{P ( q = p {h}_{j} \vert x )}{P ( q = p {h}_{j} )} \cdot p ( x ) \qquad ( Equation 7 )$$

The Viterbi Algorithm may evaluate the trellis using the Softmax output. Interpreting Equation (7), the likelihoods are obtained by dividing the posterior probabilities by the a priori probabilities, which means to divide the NN Softmax output scores by the relative frequency of each phoneme, P(q=phⱼ). Equation 7 also shows scaling the division of the posterior probabilities with the a priori probabilities by the probability of observing x, which may be estimated from the universal background model 750 of FIG. 7. If the ASP task is to select amongst a set of models (e.g., one of Y commands), then the term p(x) may be ignored since it does not depend on the state j. However, for a WW application, the HMM discriminates the WW against all false output, and hence p(x) is estimated. This is also the case for detecting out-of-vocabulary for a set of commands.

The model probability evaluated with the Viterbi algorithm is described by:

$$P ( X \vert λ ) = {\prod }_{s = 1}^{{N}_{states}} Viterbi ( {a}_{s} , p ( x \vert {q}_{s} = p {h}_{j} ) ) \qquad ( Equation 8 )$$

where aₛ is the transition probability vector, such as {αᵢⱼ, αⱼⱼ, αₖⱼ} of FIG. 17B.

Substituting Equation 7 for p (x|q=phⱼ) into Equation 8 yields:

$$P ( X \vert λ ) = {\prod }_{s = 1}^{{N}_{states}} Viterbi ( {a}_{s} , \frac{P ( {q}_{s} = p {h}_{j} \vert x )}{P ( {q}_{s} = p {h}_{j} )} \cdot p ( x ) ) \qquad ( Equation 9 )$$

In one embodiment, the HMM may evaluate P(X|λ) using a modified version of Equation 9 by including the similarity matrix formulation. Using Equation 3, Equation 8 may be modified according to:

$$P ( X \vert λ ) = {\prod }_{s = 1}^{{N}_{states}} V iterbi ( {a}_{s} , \frac{{P}_{s i m} ( {q}_{s} = p {h}_{j} \vert x )}{P ( {q}_{s} = p {h}_{j} )} \cdot p ( x ) ) \qquad ( Equation 10 )$$

Next, the HMM may incorporate multiple pronunciations. Each state may include multiple phonemes in its definition. Define the phonemes included in the definition of state s to be Ψₛ:

$${P}_{{Ψ}_{s}} = max ( {P}_{s i m} ( {q}_{s} = p {h}_{j} \vert x ) ) p {h}_{j} in \{ {Ψ}_{s} \} \qquad ( Equation 11 )$$

The HMM may then evaluate the probability of the observation sequence as:

$${P}^{{Ψ}_{s}} ( X \vert λ ) = {\prod }_{s = 1}^{{N}_{states}} Viterbi ( {a}_{s} , \frac{{P}_{{Ψ}_{s}}}{P ( {q}_{s} = p {h}_{j} )} \cdot p ( x ) ) \qquad ( Equation 12 )$$

At each frame time, t, the state with the highest likelihood is known as the most likely state,

$${s}_{M L}^{t}$$

and may be expressed as.

$${s}_{M L}^{t} = {max}_{s} ( Viterbi ( {a}_{s} , \frac{P ( {q}_{s} = p {h}_{j} \vert x )}{P ( {q}_{s} = p {h}_{j} )} \cdot p ( x ) ) \qquad ( Equation 13 )$$

Advantageously, the HMM as described automatically optimizes decoder model to different acoustic models to improve performance and accuracy. It also recognizes different accents and pronunciations.

Evaluation of the trellis using Viterbi algorithm yields the likelihood of the most probable path, but says nothing of the path itself. However, since the HMM is modeling a WW or CMD, and each state represents a phoneme in sequence from the beginning to end, it would follow that the most likely state,

$${s}_{ML}^{t} ,$$

found according to Equation (13), may also progress in sequence over time. Thus, the path in which

$${s}_{ML}^{t}$$

takes can also be used to discriminate among the state sequences. The most likely state sequence (also referred to as state walk) may be expressed as:

$${s}_{M L} = [ {s}_{M L}^{t} , {s}_{M L}^{t + 1} , {s}_{M L}^{t + 2} , … , {s}_{M L}^{t + N - 1} ] \qquad ( Equation 14 )$$

where t is the first frame in which

$${s}_{ML}^{t} > 1 ,$$

that is, the most likely state is not the initial silence state.

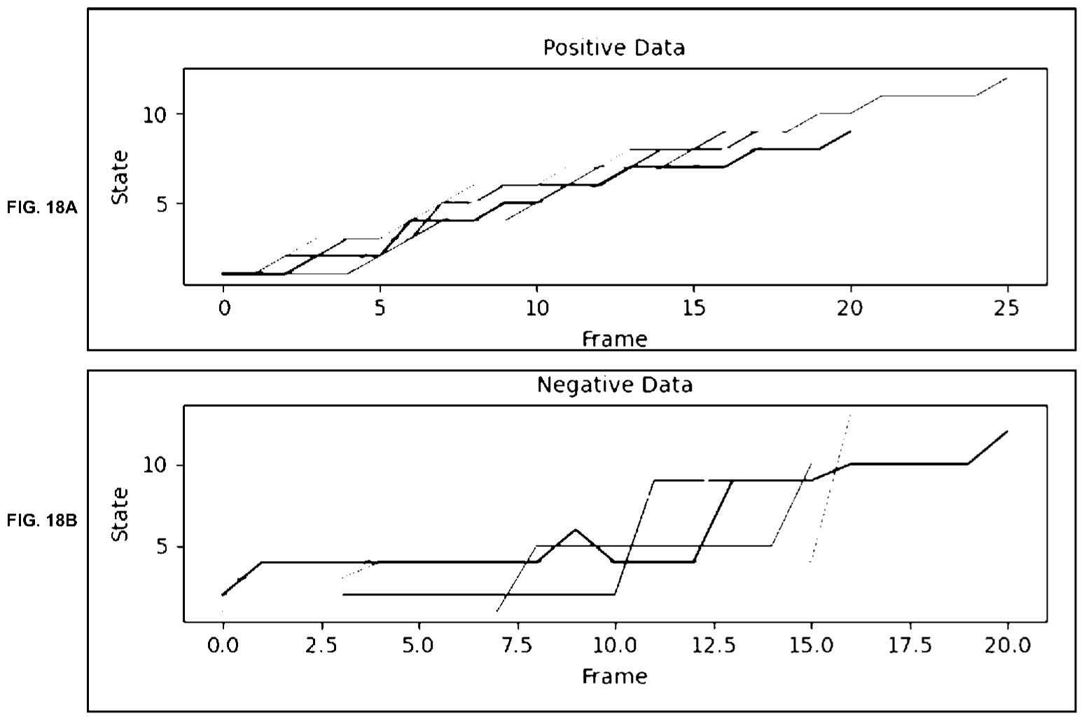

FIG. 18A depicts the most likely state walk for positive data of example WWs, in accordance with one aspect of the present disclosure. As shown, the s_{ML} generally progresses orderly through the states of the HMM for WWs matching the phonemes in the states.

FIG. 18B depicts the most likely state walk for negative data of example WWs, in accordance with one aspect of the present disclosure. As shown, the s_{ML} exhibits sporadic behavior, which make sense because the state phoneme definitions are not matching the phonemes in the speech.

Referring back to FIG. 15, the decoding compensation block 740 includes a sub-word ratio analysis block 1510, a state jump analysis block 1520, a self-transition analysis block 1530, and a top-1 statistics analysis block 1540 to improve the sequence decoding of the WWs or commands from the HMM.

In one aspect, the sub-word ratio analysis block 1510 may analyze the time length of words in the decoded sequence of a WW or command. The WW/CMD/phrase often comprises of individual words. For these words, the time (number of frames) expected for each word may be estimated. Each talker may speak slower or faster, but the ratio of length between words is expected to remain approximately consistent. If too much time is spent in one word vs. another in relation to what is expected, then it is less likely that the WW is present.

The sub-word ratio analysis block 1510 may compute the sub-word ratio penalty based on the states in the HMM representing the different words and the number of frames spent in each word using the most likely state sequence s_{ML} decoded by the Viterbi algorithm of the HMM. The sub-word ratio analysis block 1510 may compute the ratio between each word, Lᵢ and the total length of the WW, Lₜ, and compared to expected lengths, L̅ᵢ̅ and L̅ₜ̅, according to:

$${e}_{i}^{w} = \vert \frac{{L}_{i}}{{L}_{t}} - \frac{{\overline{L}}_{i}}{\overline{{L}_{t}}} \vert \qquad ( Equation 15 )$$

The sub-word ratio analysis block 1510 may compute a log likelihood penalty,

$${p}_{s w r}^{i} ,$$

according to

$${p}_{s w r}^{i} = max ( 0 , ( {e}_{i}^{w} - {TH}_{s w r} ) \cdot {R}_{s w r} ) \qquad ( Equation 16 )$$

where, in one embodiment, the default values of TH_{swr} and R_{swr} are {0.15, −15.0}.

The sub-word ratio analysis block 1510 may compute the total sub-word ratio penalty as the sum of all the sub-word penalties, p_{swr}:

$${p}_{s w r} = {\sum }_{i = 1}^{{N}_{w o r d s}} {p}_{s w r}^{i} \qquad ( Equation 17 )$$

where N_{words} are the number of sub-words in the WW or command.

In one aspect, the state jump analysis block 1520 may analyze state jumps or skipping in the s_{ML}. Since every state in the HMM represents a phoneme in the pronunciation of the desired word, s_{ML} should include every state. When there are skipping or jumping states in the s_{ML} it implies that the phoneme was not present in the input speech.

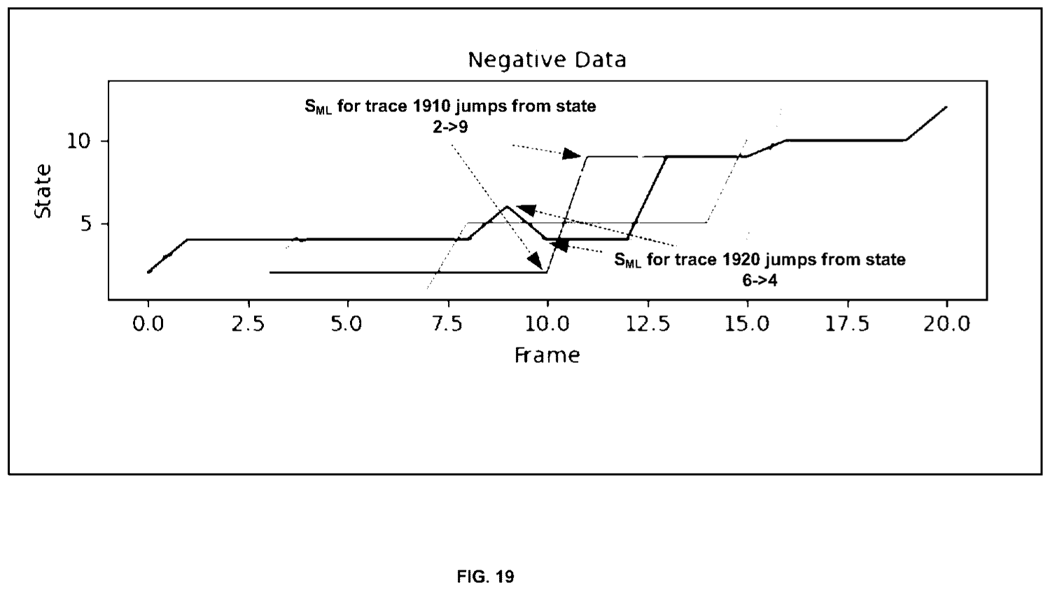

FIG. 19 depicts the most likely state walk s_{ML} for negative data of example WWs as in FIG. 18B but highlighted to show the state jumps, in accordance with one aspect of the present disclosure. The s_{ML} for trace 1910 exhibits a jump from state 2 at frame 10 to state 9 at frame 11, thus jumping over 6 states in the model. In the same figure, the s_{ML} for trace 1920 jumps backwards from state 6 at frame 9 to state 4 at frame 10, implying that phonemes are appearing out of order in the input signal. Both scenarios indicate that the target WW modeled by the HMM is likely not present in the speech.

The state jump analysis block 1520 may compute the state jump penalty, pₛⱼ, as the weighted sum of all of the state jumps found in s_{ML} according to:

$${p}_{s j} = {\sum }_{t = {t}_{s t a r t}}^{{t}_{e n d}} \vert {s}_{ML}^{t} - ( {s}_{ML}^{t - 1} + 1 ) \vert \cdot {R}_{sjp} \qquad ( Equation 18 )$$

where

$${s}_{ML}^{t} and {s}_{ML}^{t - 1}$$

are the states of s_{ML} at frames t and t−1, respectively, and Rₛⱼₚ is a state jump weighting factor. In one embodiment, the default value of Rₛⱼₚ is {−0.5}.

In one aspect, the self-transition analysis block 1530 may analyze the self-transition probability for each state in the s_{ML}. The average length of each phoneme, L̅ₚₕ_{ⱼ}, can be found offline from a speech database for the modeled language. Since each state in the HMM represents a phoneme, the self-transition probability, P(sⱼ|sⱼ), is related to L̅ₚₕ_{ⱼ} according to:

$$P ( {s}_{j} \vert {s}_{j} ) = 1 - \frac{{t}_{frame}}{{\overline{L}}_{p {h}_{j}}} \qquad ( Equation 19 )$$

where t_{frame} is the time for each frame.

Hence

$$\frac{{\overline{L}}_{{ph}_{j}}}{{t}_{frame}}$$

is the expected number of frames in the corresponding state for which phⱼ is the preferred pronunciation. The self-transition analysis block 1530 may compare this expected number to the observed number of consecutive frames that the s_{ML} spends in a state. If the observed number of frames for a state substantially exceeds the expected number of frames, it is less likely that the WW is present.

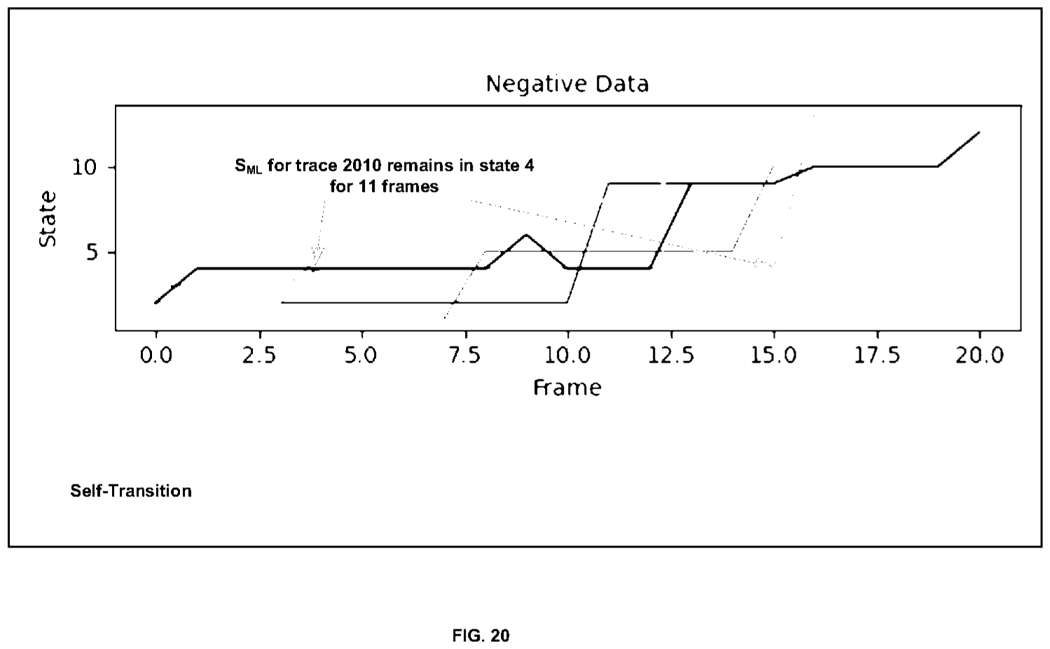

FIG. 20 depicts the most likely state walk s_{ML} for negative data of example WWs as in FIG. 18B to show the number of frames the s_{ML} remains in each state, in accordance with one aspect of the present disclosure. For example, the s_{ML} for trace 2010 remains in state 4 for 11 frames from frame 4 to frame 15.

The self-transition analysis block 1530 may quantify the difference between the observed and the expected number of frames the s_{ML} remains in each state. Let

$${n}_{self}^{i}$$

be the number of consecutive self-transitions starting from

$${j}_{start}^{i} ,$$

and L̅ₚₕ_{ₛ} be the expected length of the preferred pronunciation phoneme of state s. Then the self-transition penalty, pₛₜ, is given by:

$${P}_{st} = {\sum }_{i = 1}^{N} log ( P ( {s}_{{j}_{start}^{i}} \vert {s}_{{j}_{start}^{i}} ) ) \cdot ( max ( 0 , ( {n}_{self}^{i} - ⌈ \frac{{\overline{L}}_{p {h}_{s}}}{{t}_{frame}} ⌉ ) ) ) \cdot {R}_{st} \qquad ( Equation 20 )$$

where Rₛₜ is a self-transition factor. In one embodiment, Rₛₜ may have a default value of 0.5.

Equation 20 shows that if the difference between the observed self-transition length and the expected length of the phoneme is greater than zero, multiply this difference by the self-transition factor, Rₛₜ, and then multiply by the log of the self-transition probability to compute the self-transition penalty for the state corresponding to the phoneme. Equation 20 computes a sum of all such formulations for the self-transitions in the current state walk. This formulation is proportional not only to the number of frames beyond that expected, but also by how quickly a state is expected to transition to the next state. For example, if the number of self-transitions has exceeded the expected by 2 frames, then the penalty is log

$$( P ( {s}_{{j}_{start}^{i}} \vert {s}_{{j}_{start}^{i}} )$$

if Rₛₜ is 0.5. If it is highly likely for the state to stay in its current state, then

$$P ( {s}_{{j}_{start}^{i}} \vert {s}_{{j}_{start}^{i}} )$$

is close to 1, and log

$$P ( {s}_{{j}_{start}^{i}} \vert {s}_{{j}_{start}^{i}} ) ≅ 0.$$

This makes sense because exceeding by 2 frames is more likely in this case. However, if the phoneme length is short, then the self-transition probability is low. For example, if P

$$( {s}_{{j}_{start}^{i}} \vert {s}_{{j}_{start}^{i}} ) = 0.1 ,$$

then log

$$P ( {s}_{{j}_{start}^{i}} \vert {s}_{{j}_{start}^{i}} ) = - 1.$$

In this case, exceeding the expected length by 2 frames when the probability to transition is 0.9 is highly unlikely, and hence, the self-transition penalty is larger.

In one aspect, the top-1 statistics analysis block 1540 may weigh the s_{ML} based on how well the s_{ML} matches the expected phonemes of the WW or command. The motivation for the analysis is that even though the HMM captures well the likelihood of the input given the model, P(X|λ), it does not inherently give weight to the absolute ranking of the phonemes in the Softmax output.

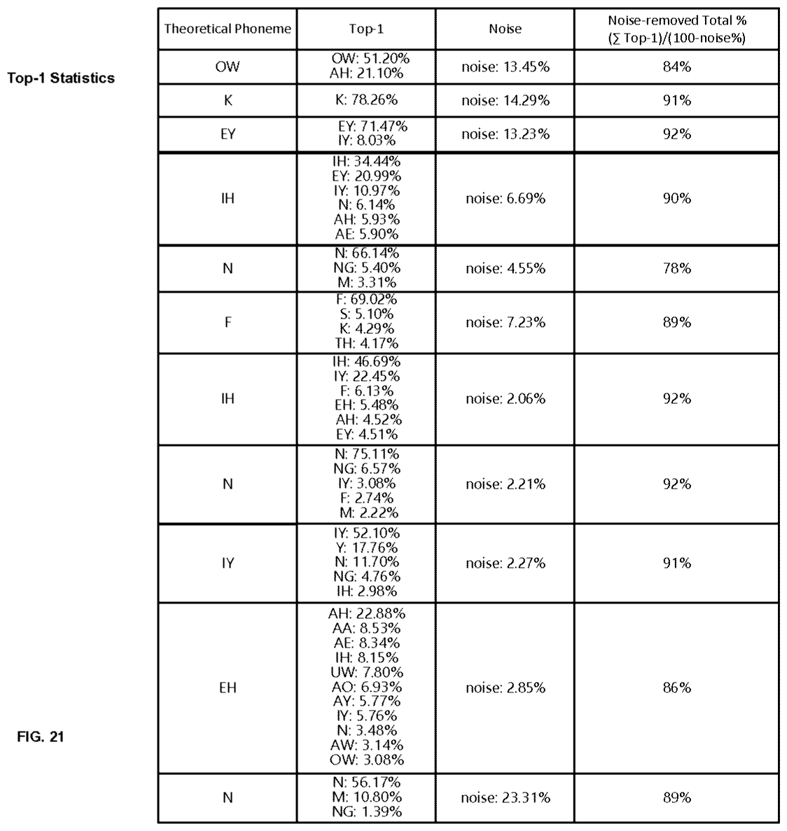

FIG. 21 depicts the top-1 statistics of the phonemes for the WW ‘Okay Infineon,’ in accordance with one aspect of the present disclosure. The table indicates which phonemes are predicted correctly with what degree of accuracy. For example, the ‘K’ is the top ranked phoneme in the Softmax vector 78% (91% if spurious noise class is removed) of the time during the time interval marked as ‘K’. Therefore, there is a high degree of confidence that during decoding, when the most likely state corresponds to the ‘K’ state, that the top phoneme in the Softmax vector is ‘K’. Likewise, if ‘K’ is not found to be the highest ranked phoneme in the Softmax vector during this time, it would seem very unlikely that the WW is present, no matter what the overall model likelihood is. On the other hand, the second to last state labeled ‘EH’ has several phonemes commonly ranked first. In this case, there should not be much weight placed on the top-1 phoneme during those frames in that state.

Define Top1(state, phoneme) as the top-1 ranking fraction for the phoneme ‘phone’ in HMM state ‘state’. Hence, from Table 1, Top1(1, OW)=0.312. Define

$${ph}_{1}^{t}$$

to be the phoneme at time t whose Softmax score is the highest:

$${ph}_{1}^{i} = argmax ( Softmax ( t ) ) \qquad ( Equation 21 )$$

$$Then$$

$${score}_{1} ( t ) = log ( \frac{Top 1 ( {s}_{ML}^{t} , {ph}_{1}^{t} )}{P ( q = {ph}_{1}^{t} )} ) \qquad ( Equation 22 )$$

where

$$P ( q = {ph}_{1}^{t} )$$

is the prior probability.

The top-1 statistics analysis block 1540 may tally the score at each frame t according to state

$$( s = {s}_{ML}^{t} )$$

and then may average the scores for each state. The top-1 statistics analysis block 1540 may average the average score in each state across states to obtain a final top1 score, scoreₜₒₚ₁. If there are no scores in a state, then that state may obtain a score average of −1. The final penalty, pₜₒₚ₁ is then obtained by:

$${p}_{top 1} = {score}_{top 1} \cdot {R}_{top 1} \qquad ( Equation 23 )$$

where Rₜₒₚ₁ is the top-1 score factor. In one embodiment, Rₜₒₚ₁ may have a default value of 3.0.

The formulation of pₜₒₚ₁ rewards top-1 sequences matching that expected, giving extra weight to those phonemes highly expected to be in the top-1, while penalizing top-1 sequences that do not match, again especially those not matching phonemes highly expected to be ranked top-1. Note that the final penalty, pₜₒₚ₁, can be positive or negative.

The total compensations, p_{ZNN} is the sum of all of the individual compensations:

$${p}_{ZNN} = {p}_{swr} + {p}_{sj} + {p}_{st} + {p}_{top 1} \qquad ( Equation 24 )$$

where
p_{swr} is the total sub-word ratio penalty of Equation 17;
pₛⱼ is the state jump penalty of Equation 18;
pₛₜ is the self-transition penalty of Equation 20; and
pₜₒₚ₁ is the top-1 score penalty of Equation 23.

The decoding compensation block 740 may improve the sequence decoding of the WWs or commands from the HMM by modifying the model likelihood score, P(X|λ), at time, t, according to:

$$score [ t ] = log ( {P ( X \vert λ )}^{t} ) + {p}_{ZNN} \qquad ( Equation 25 )$$

Advantageously, use of the decoding compensation block 740 on different WW models demonstrate a 50-90% reduction in the false alarm (FA) rate. The decoding compensation block 740 is integrated within the decoding, and operates frame-by-frame, thus working seamlessly with the Viterbi algorithm, and introducing essentially no additional algorithm or processing delay.

In one aspect, a set of sequence decoding structures customized to the user-defined command set may support any combination of WW, simple commands, compound commands, and numbers-based commands.

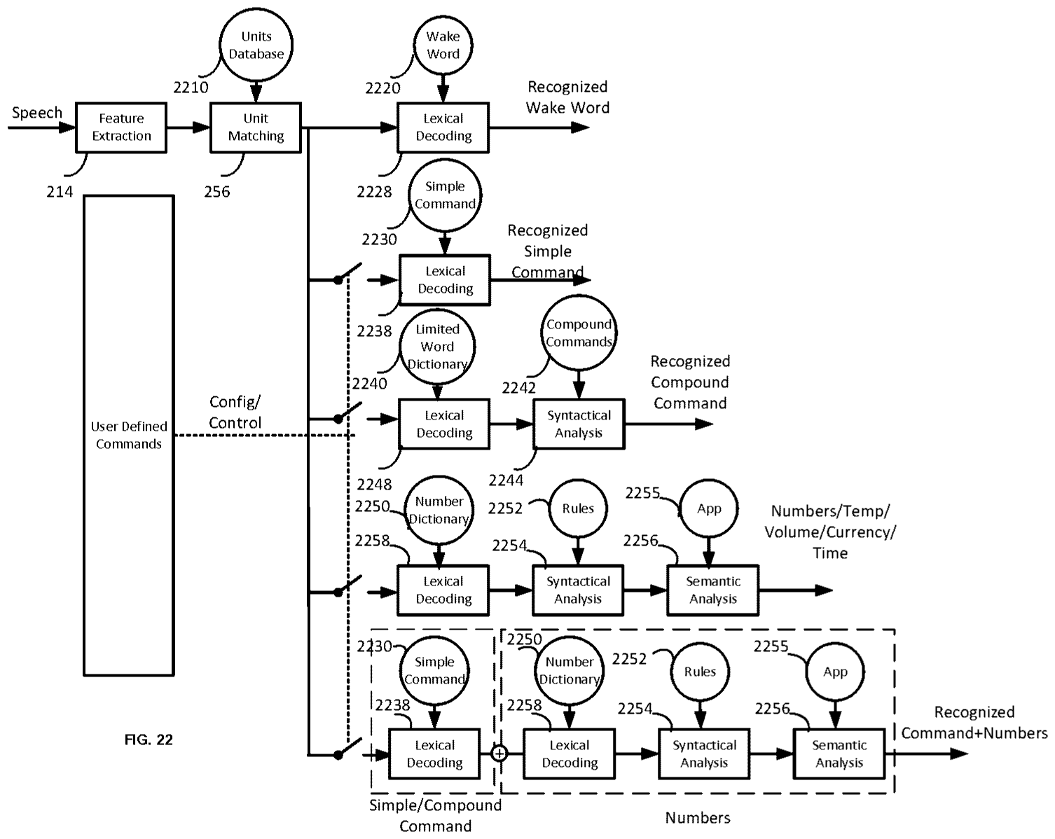

FIG. 22 depicts sequence decoding structures for a user-defined command set, in accordance with one aspect of the present disclosure. The user-defined command set may include WWs, simple commands, compound commands, number-based commands with units, and complex commands that include combinations of commands, numbers, and units. The sequence decoding structures may include different combinations of structure blocks such as lexical decoding blocks, syntactical analysis blocks, semantic analysis blocks for the different command types in the command set. The structure blocks may include HMM to perform the decoding or analysis. In one embodiment, the sequence decoding structures may combine the internal HMM of cascading structure blocks into a single HMM.

The sequence decoding structure for WWs is similar to that depicted in FIG. 2. The structure may include the feature analysis module 214 to perform spectral and/or temporal analysis of the speech for processing by the NN-based unit matching block 256 based on a unit database 2210 such as an acoustic model. A lexical decoding block 2228 may process the sequence of phoneme likelihood vectors from the unit matching block 256 to render a recognized WW based on characteristics of the WW, such as restrictions on possible sequences of phonemes due to the structure of the WW. In one embodiment, the WW is a phrase such as “Okay Infineon” that has two words. The lexical decoding block 2228 may decode the WW phrase using a single structure block that combines the phonemes of the two words.

A simple command may include constituent words that contain little or no commonality with other commands. For example, a simple command may be the command to “take a picture,” or to “set alarm clock to snooze.” Similar to the decoding structure for WWs, a single structure block for decoding simple commands may include a lexical decoding block 2238 trained to recognize one or more simple commands 2230. The lexical decoding block 2238 may process the sequence of phoneme likelihood vectors from the unit matching block 256 to render a recognized simple command by modeling the combined phonemes of the constituent words of the simple command.

Compound commands may include a mix of sub-commands that are common and sub-commands that are unique to each compound command. For example, the four compound commands 1) “Turn the light on in the living room;” 2) “Turn the light on on the porch;” 3) “Turn the light on behind the study desk;” and 4) “Turn the light on by the stove,” may be split into the common sub-command “Turn the light on” followed by the four unique second stage sub-commands.

A sequence decoding structure for decoding compound commands may include a lexical decoding block 2248 trained to recognize common sub-commands and unique sub-commands based on a limited word dictionary 2240. A syntactical analysis block 2244 trained to recognize one or more compound commands 2242 may apply constraints based on word grammar and proper sequencing to evaluate the common sub-commands and unique sub-commands. For example, if the syntactical analysis block 2244 recognizes “Turn the light on,” the syntactical analysis block 2244 may evaluate the set of the four second stage sub-commands to render a recognized compound command.

If a command includes only a few numbers, such “Set the dial to {1,2},” then the command can be unrolled into two separate simple commands, or into a compound command. However, this becomes impractical when the number range is large, such as setting the temperature of an oven to “two hundred forty seven degrees.” A sequence decoding structure for decoding a large number range followed by units of the numbers such as temperature, volume, currency, time, etc., (referred to as number-based entities) may include a lexical decoding block 2258 trained to recognize numbers and units based on a number/unit dictionary 2250. A syntactical analysis block 2254 trained to recognize numbers followed by units may apply rules 2252 to evaluate the sequence of numbers and units. Number decoding may need to consider the past and current to determine the future. For example, the number “two” could be the end of recognition if the expected range is digits, or it may be followed by “hundred” or something else if a larger range is defined. Thus, number decoding may include a semantic analysis block 2255 trained to evaluate commands based on constraints such as meaning, reference, logic, implication, application, etc., (collectively app 2255) to render a recognized number-based entity.

A complex command may include a simple or compound command followed by a large range of numbers and a unit. For example, a complex command may be the command to “set oven temperature to two hundred forty seven degrees.” A sequence decoding structure for decoding complex commands may combine the structure blocks of a decoding structure for simple commands, compound commands, and number-based entities. For example, a sequence decoding structure for complex commands may include a lexical decoding block 2238 trained to recognize one or more simple commands 2230, a lexical decoding structure 2258 trained to recognize numbers and units based on a number/unit dictionary 2250, a syntactical analysis block 2254 trained to recognize numbers followed by units based on rules 2252, and a semantic analysis block 2255 trained to evaluate number-based entities based on constraints in app 2255. The sequence decoding structure may render a recognized complex command composed of a simple command followed by a number-based entity.

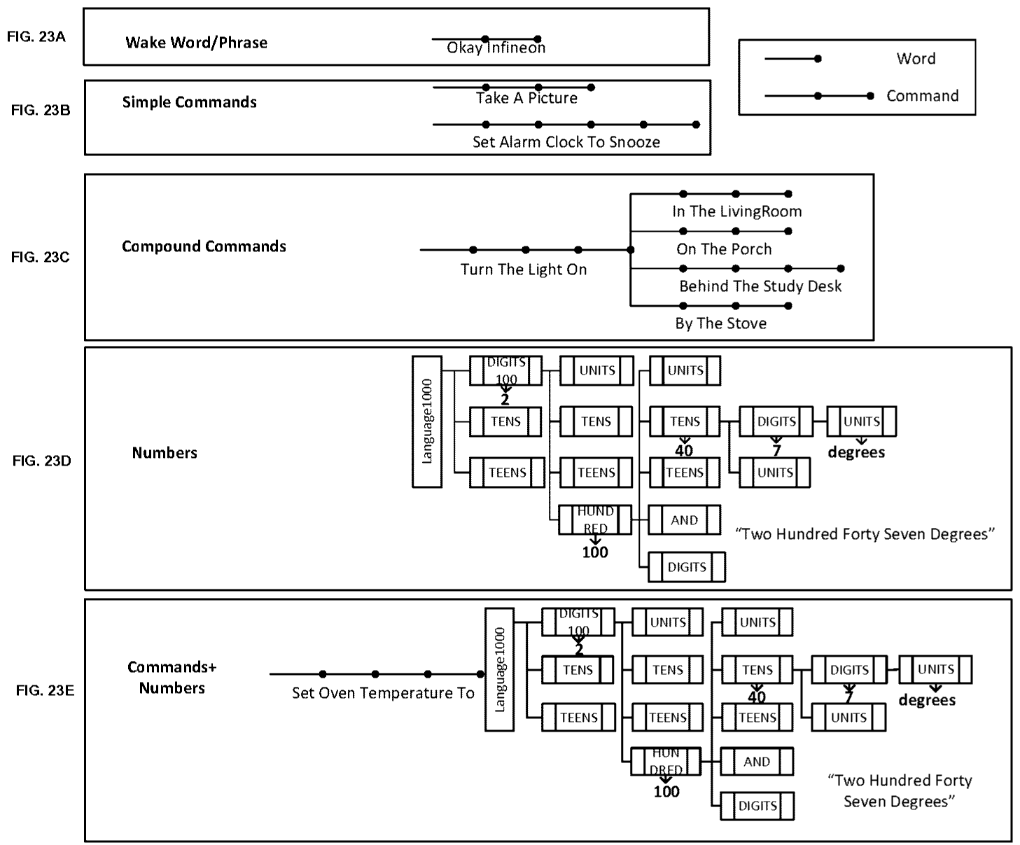

FIG. 23A depicts the constituent words for the WW “Okay Infineon” recognized by the sequence decoding structure for WWs of FIG. 22, in accordance with one aspect of the present disclosure.

FIG. 23B depicts the constituent words for the simple commands “Take a picture,” and “Set alarm clock to snooze,” recognized by the sequence decoding structure for simple commands of FIG. 22, in accordance with one aspect of the present disclosure.

FIG. 23C depicts the constituent common sub-command and the four second stage sub-commands for the four compound commands 1) “Turn the light on in the living room;” 2) “Turn the light on on the porch;” 3) “Turn the light on behind the study desk;” and 4) “Turn the light on by the stove,” recognized by the sequence decoding structure for compound commands of FIG. 22, in accordance with one aspect of the present disclosure.

FIG. 23D depicts the constituent number range and a unit for the number-based entity “two hundred forty seven degrees” recognized by the sequence decoding structure for decoding a large number range followed by a unit of FIG. 22, in accordance with one aspect of the present disclosure.

FIG. 23E depict the constituent simple command, number range, and a unit for the complex command “Set oven temperature to two hundred forty seven degrees,” recognized by the sequence decoding structure for complex commands of FIG. 22, in accordance with one aspect of the present disclosure.

A user may define the WWs and commands in the command set and may invoke a design flow to map the user-defined command set to the desired sequence decoding structures as part of a training process.

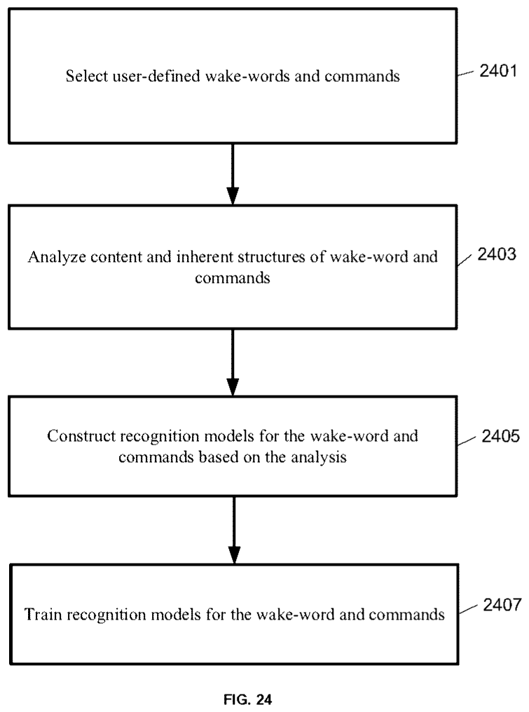

FIG. 24 illustrates a flow diagram of a method 2400 for constructing the sequence decoding structures to recognize WWs or commands from a user-defined command set, in accordance with one aspect of the present disclosure. In one aspect, method 2400 may be performed by a data free speech recognition system utilizing hardware, software, or combinations of hardware and software.

In operation 2401, the data free speech recognition system may select user-defined WWs and commands.

In operation 2403, the data free speech recognition system may analyze content and inherent structure of the WWs and commands. In one embodiment, the WWs may include multiple constituent words, and the commands may be classified as simple commands, compound commands, number-based entities, and complex commands that include combinations of simple/complex commands and number-based entities.

In operation 2405, the data free speech recognition system may construct recognition models for the WWs and commands based on the analysis. In one embodiment, the recognition models may include sequence decoding structures such as a HMM that evaluate the probability of the observation sequence, P(X|λ), given the model A of the HMM.

In operation 2407, data free speech recognition system may train the recognition model to recognize the WWs and commands (e.g., target phrases). In one embodiment, an “online training” process as described in FIG. 3 may train the recognition model based on a tokenizer that converts the text of a target phrase in the user-defined command set to its phoneme string equivalent. The recognition model may be trained to achieve a highly accurate, robust, decoding approach that is adaptive to an acoustic model and to alternate pronunciations of the target phrase.

The data free speech recognition system may deploy the recognitions models to detect WWs and commands in speech during the inference stage as discussed in FIG. 4. After the recognition model for WWs detects a WW, recognition models for the commands may evaluate the follow-on commands.

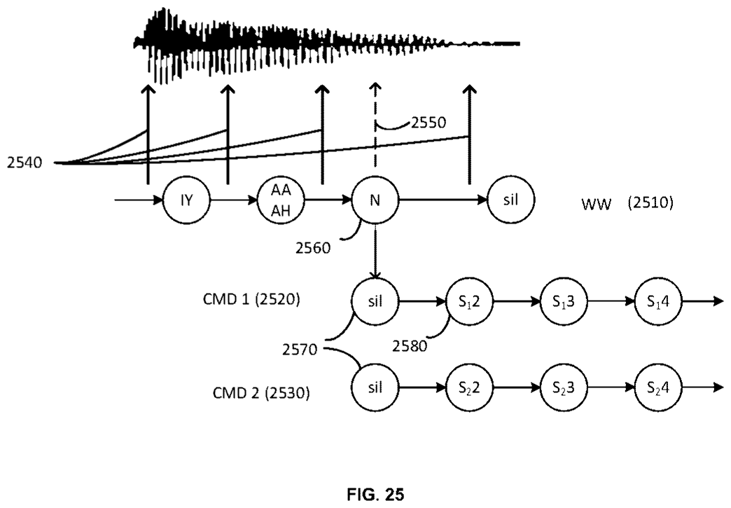

FIG. 25 depicts the recognition model for the WW detecting “Okay Infineon” 2510 and two following recognition models for CMD1 (2520) and CMD 2 (2530) evaluating a follow-on command, in accordance with one aspect of the present disclosure. Lines 2540 mark the approximate transition from one phoneme to the next in the audio corresponding to “eon”. The recognition model for WWs declares the WW at frame 2550 and the recognition models for the commands evaluate the follow-on command in following frames. FIG. 25 shows that the phoneme /N/ (2560) has not finished at the point that the WW is declared at frame 2550 (e.g., the transition 2540 from the phoneme /N/ (2560) occurs after frame 2550). This may cause potential decoding errors in the evaluation of the follow-on command since the recognition models for the commands are not constructed to model the end of the WW. For example, the first state of the command models is /SIL/ 2570 but the current processing frame has not yet reached the silence region, potentially causing the command models to miss recognizing a command.

Another potential issue is the random-likeness of the last non-silence WW state and the first non-silence (S2) state of the command models. For example, if CMD1 (2520) starts with the word “Next” then S₁2 (2580) will be modeled by phoneme /N/ and happens to match well with the /N/ (2560) from the end of “Infineon”. CMD 2 (2530) may not match the /N/ (2560). Hence, CMD1 (2520) may have a higher initial likelihood than CMD 2 (2530), completely unrelated to the command being spoken. This results in a bias towards CMD 1 (2520) and a decrease in performance of the command models. In one aspect, the command models may compensate for the WW-to-command transition.

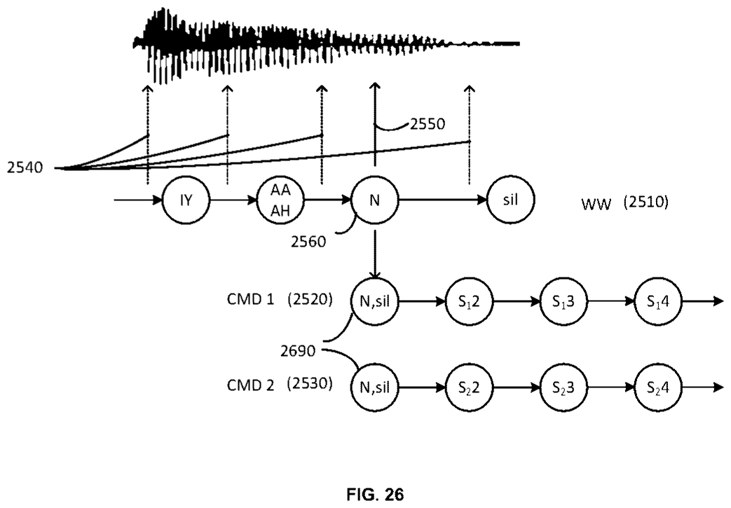

FIG. 26 depicts the recognition model for the WW detecting “Okay Infineon” 2510 and two following recognition models for CMD1 (2520) and CMD 2 (2530) evaluating a follow-on command with a state compensation technique, in accordance with one aspect of the present disclosure. The command models may include the last non-silence state of the WW as an alternate pronunciation to the leading /SIL/ state of each command. FIG. 26 shows that /N/ (2560) is added to the /SIL/ state 2690 of CMD1 (2520) and CMD2 (2530). The resulting state models the end of the WW perfectly, matching both the trailing /N/ (2560) and any silence between the WW and CMD. The modified state also eliminates any random bias from commands that coincidentally match their leading phoneme with the trailing phoneme of the WW.

A recognition model for a command concatenates each word of the command into a single model, each word separated by a silence state. However, the amount or even presence of a silence gap between words is quite variable, depending on the words and the talker. In one aspect, to better handle command-to-command transitions, a command model may include last non-silence state from the preceding word and the first non-silence state from the following word into the silence state modeling the gap.

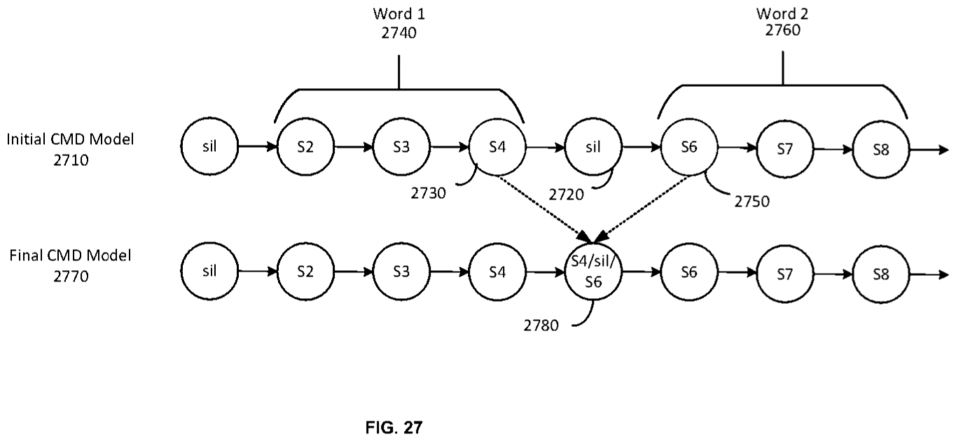

FIG. 27 depicts modifying the recognition model for the WW to account for variable silence gap between words, in accordance with one aspect of the present disclosure. The initial CMD model 2710 shows a silence state 2720 between the last non-silence phoneme S4 (2730) of word 1 (2740) and the first non-silence phoneme (2750) of word 2 (2760). The final CMD model 2770 shows the modified silence state 2780 now include the last non-silence phoneme S4 (2730) of word 1 (2740) and the first non-silence phoneme (2750) of word 2 (2760). The inclusion of the non-silence phonemes is equivalent to including alternate pronunciations for a state. The modified state may handle both situations when the silence gap is present or absent.

In one embodiment, a compound command composed of multiple stage sub-commands may have modified states for sub-command transitions similar to that for a simple command. However, the first stage sub-command may include only a preceding silence state (decoding only a silence gap) and no trailing silence state. Intermediate sub-commands may not contain preceding or trailing silence states. The final stage sub-command may include only a trailing silence state and no preceding silence state.

As discussed in operation 2407 of FIG. 24, an online training process may train the recognition models to recognize the WWs and commands (e.g., target phrases) based on a tokenizer that converts the text of a target phrase in the user-defined command set to its phoneme string equivalent, or other basic units referred to as tokens. The tokenizer analyzes the input text to identify its constituent graphemes and produces a sequence of tokens based on predefined rules, statistics, or learned patterns. For example, the tokenizer converts graphemes, the smallest units of representation of a language in written form, into phonemes, the smallest audio building blocks of a language.

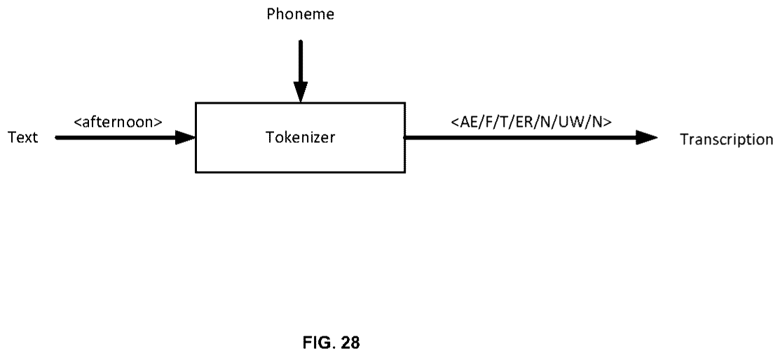

FIG. 28 depicts a phoneme tokenizer that converts the graphemes in the input text “afternoon” into a string of phonemes, in accordance with one aspect of the present disclosure. There are several approaches available for tokenizers, including rule-based, statistical models, and machine learning based approaches. Rule-based approaches are based on a set of predefined linguistic rules and exceptions. Such approaches required significant domain knowledge from experts in the field and are limited in performance due to irregularities and exceptions common in many languages including English. Statistical models use large annotated datasets containing already transcribed text-to-phoneme pairs to learn the pronunciation of new or unseen words. Machine learning based approaches use deep learning models such as Long Short-Term Memory (LSTM) networks to learn the grapheme-to-phoneme (G2P) task. The recurrent nature of the LSTM model incorporates the context and order of graphemes into the learning to achieve high accuracy.

Tokenizers based on machine learning or deep learning approaches may achieve high transcription accuracy when performing the G2P task. However, their performance relies heavily on both the quality and volume of the training data based on real speech. Training databases may be restricted for use, expensive to obtain, or may not exist in enough quantity, especially for different languages, to properly train the models. It is also desirable to train the tokenizers to support different accents, dialects, and languages.

Described is a statistics-based tokenizer solution that includes a training phase and a decoder phase. In the training phase, the tokenizer may process words from a reference phonetic dictionary containing word-token transcriptions. The tokenizer may break words in the dictionary into sub-words and may compile statistics to generate a custom dictionary containing sub-words and their estimated likelihoods.

In the decoding phase, the tokenizer may analyze the text input, perform a sub-word search, and solve iteratively using the sub-words and their likelihoods from the custom dictionary to maximize the token stream probability. In one aspect, during the decoding phase, the tokenizer may analyze the text input of target phrases in the user-defined command set using the dictionary of sub-words and their estimated likelihoods to tabulate the most likely phoneme string equivalents of the text input and their likelihoods. The data free speech recognition system may use the top-N phoneme string equivalents for online training of the recognition models of the target phrases such that sequence decoding of the speech of the target phrases are adaptive to the offline trained acoustic model.

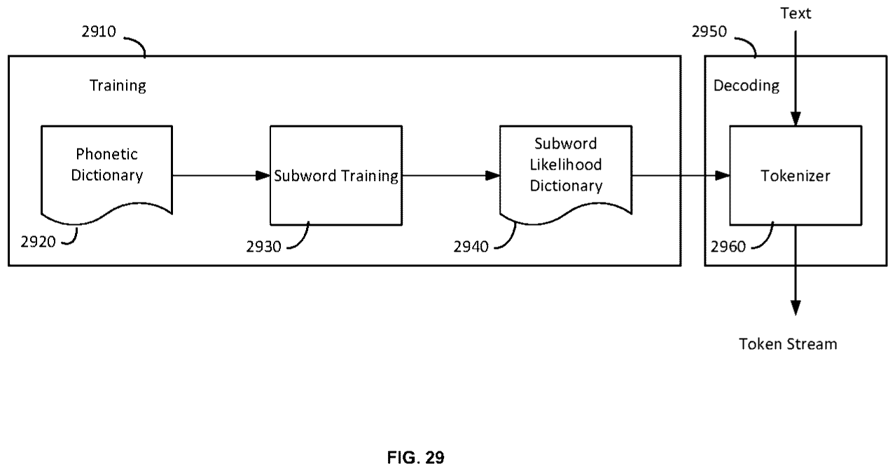

FIG. 29 depicts a block diagram of the training phase 2910 and the decoding phase 2950 of a tokenizer 2960, in accordance with one aspect of the present disclosure. The train phase 2910 uses a reference phonetic dictionary 2920 containing word-token transcriptions as input. The tokenizer 2960 may break each training word in the phonetic dictionary 2920 into multiple unique sub-words by splitting the word at different points for a sub-word training task 2930. The sub-word training task 2930 may assign phonemes to the sub-words splits based on a mapping between the graphemes and phonemes and positional information of the sub-words within the corresponding training word. The sub-word training task 2930 may accumulate the results of the phoneme-sub-word assignments for all the training words in the phonetic dictionary 2920 to compile a sub-word likelihood dictionary 2940 containing the probability of each unique combination of phonemes, sub-words, and positional information of the sub-words within a word.

In the decoding phase 2950, the tokenizer 2960 may split a target text input, such as text input of target phrases in the user-defined command set, into different unique combinations of sub-words. The tokenizer 2960 may perform a search of each sub-word of the combinations in the sub-word likelihood dictionary 2940 to find the phoneme corresponding to the sub-word and the sub-word's position within the target text input. Each combination of phoneme, sub-word, and the sub-word's position has a corresponding probability. The tokenizer 2960 may multiply the corresponding probabilities for all the sub-words in each unique combination of sub-word split to obtain the probability of the combination. The tokenizer 2960 may solve for the most likely combination among all the combinations to maximize the probability of the phoneme string equivalent for the target text.

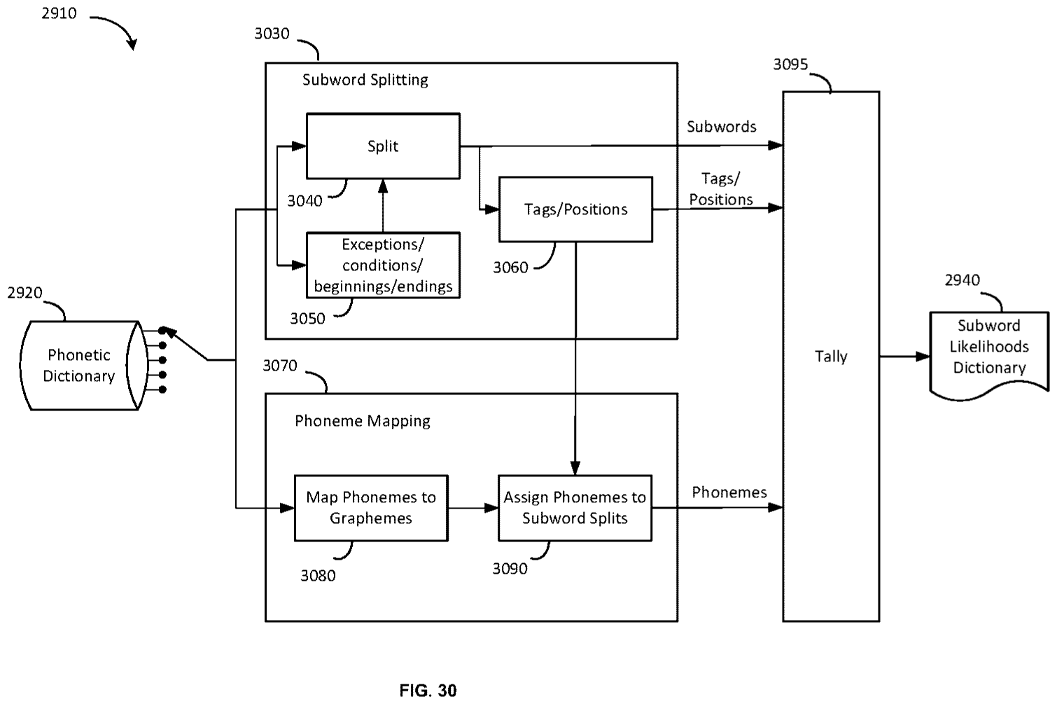

FIG. 30 depicts a block diagram of the training phase 2910 of a tokenizer using a reference phonetic dictionary 2920, in accordance with one aspect of the present disclosure. The training phase 2910 may sequence through the words of the phonetic dictionary 2920 to feed each word to a sub-word splitting block 3030 and a phoneme mapping block 3070. The sub-word splitting block 3030 may analyze the text of the training word from the phonetic dictionary 2920 and may create multiple unique “sub-words” by splitting it at different points. The splits of the sub-words may be associated with tags and positions to indicate how the training words are split. The phoneme mapping block 3070 may map the input phoneme string of the current training word to different graphemes. The phoneme mapping block 3070 may use the tags and positions of each split to assign phonemes to the sub-words. A tally block 3095 may tally the sub-words, their tags/positions, and the associated phoneme for all of the training words in the phonetic dictionary 2920 to create a sub-word based dictionary with likelihoods 2940.

In one embodiment of the sub-word splitting block 3030, a split block 3040 splits the current dictionary word into different sub-words. For example, splitting may proceed one grapheme at a time from the beginning of the word, and/or from the end of the word, and/or in both directions from the middle or other starting point. In one embodiment, the sub-words may have a minimum length of 2 graphemes.

The split block 3040 may consider certain exceptions, conditions, rules for common beginnings/common endings, etc., 3050, when splitting. For example, in English, certain grapheme pairs exist that constitute a single phoneme such as [‘ph’, ‘sh’, ‘ch’, ‘th’, ‘ck’, ‘ng’, ‘ll’, ‘ss’, ‘tt’, ‘aw’]. If the split block 3040 observes these pairs, the split block 3040 will not split the pairs and will consider each pair as a single grapheme unit. The split block 3040 may employ other exceptions or rules to improve the splitting such as common endings [‘ing’, ‘ion’, etc.].

A tag/position block 3060 may categorize the different positions of the sub-words within the original word into tags. For example, the tag/position block 3060 may assign the tags <Start>, <Middle>, <End> to categorize sub-words that are positioned at the start, middle, or end of the word. The tag/position block 3060 may assign the tag <Full> for a sub-word that constitutes the complete original word. In addition, the tag/position block 3060 may assign the grapheme starting position number to track the original location of the sub-word within the word.

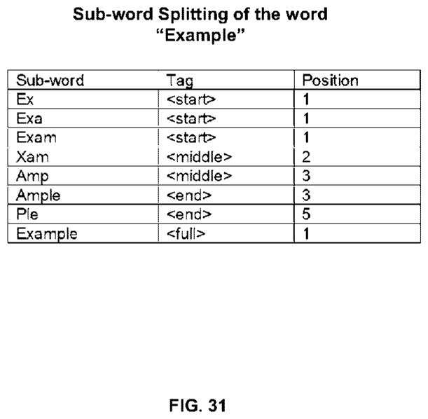

FIG. 31 depict sub-word splitting and the associated tags and positions of the sub-words for the word “Example” at different points, in accordance with one aspect of the present disclosure. As shown, the sub-words have a minimum length of 2 graphemes.

Referring back to FIG. 30, the phonetic dictionary 2920 contains grapheme-phoneme pairs for words in a target language. In one embodiment of the phoneme mapping block 3070, a map-phonemes-to-graphemes block 3080 may map the graphemes to their respective phonemes for each given word in the dictionary being processed. The mapping may also take into consideration special exceptions, conditions, grapheme pairs, common beginnings/endings etc., 3050, of the graphemes. The mapping may be associated with a position to indicate the position number of the graphemes within the word.

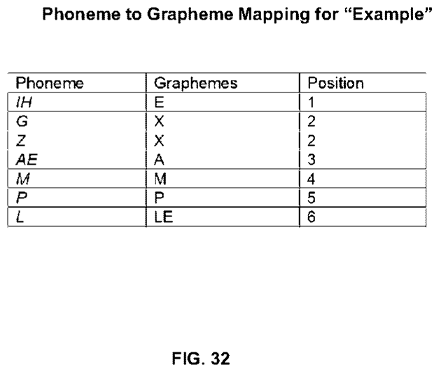

FIG. 32 depicts a phoneme-to-grapheme mapping for the word “Example” and the positions associated with the graphemes, in accordance with one aspect of the present disclosure. The mapping illustrates there may be both one-to-many and many-to-one mappings between phonemes and graphemes.

Referring back to FIG. 30, an assign phonemes-to-sub-words-splits block 3090 may use the phoneme-to-grapheme mapping to assign phonemes to the sub-words according to the graphemes contained in the sub-word splits. The phonemes-to-sub-word assignment may take into account the tags and/or the positions associated with the sub-words to create a {sub-word, phoneme, tag} triplet.

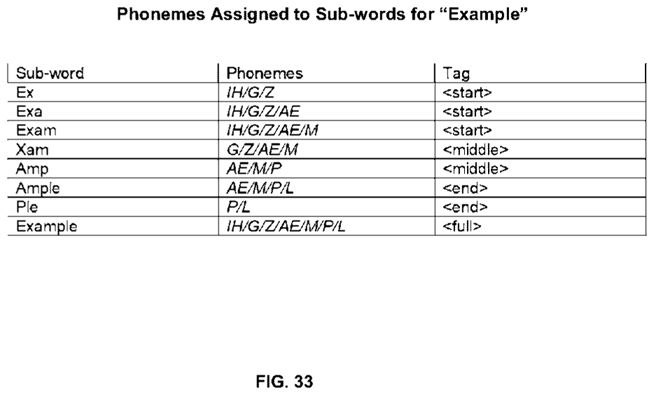

FIG. 33 depicts a phonemes-to-sub-words assignment for the word “Example” for the sub-word splits of “Example” of FIG. 31 using the phoneme-to-grapheme mapping of FIG. 32, in accordance with one aspect of the present disclosure. The assignment shows the tags associated with the sub-words in the {sub-word, phoneme, tag} triplet.

Referring back to FIG. 30, the tally block 3095 may accumulate the results of the phonemes-to-sub-words assignments produced for each word and may compute the likelihood (probability) of each unique {sub-word, phoneme, tag} triplet to create the sub-word likelihoods dictionary 2940.

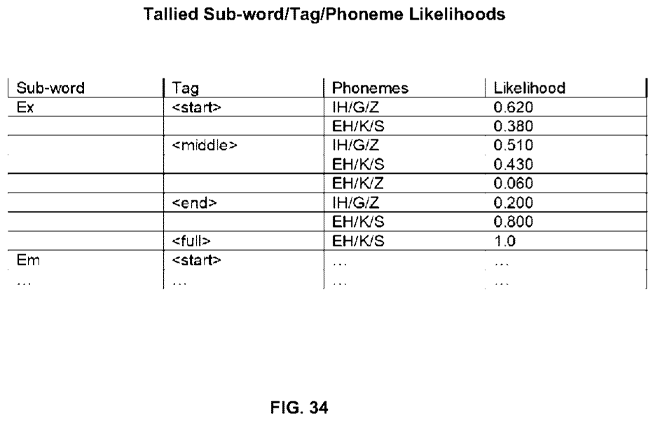

FIG. 34 depicts the tallied triplet {sub-word, tag, phoneme} and the probability of each triplet for all the words in the phonetic dictionary 2920, in accordance with one aspect of the present disclosure. Each sub-word lists all the possible tag categories for the sub-word. The probabilities of all the possible phonemes sum to 1.0 for each {sub-word, tag} pair. For example, for the sub-word “Ex” associated with the <start> tag, there are two possible phoneme assignments {IH/G/Z} and {EH/K/S} with their respective probabilities of 0.620 and 0.380 summing to 1.

The sub-word likelihoods dictionary 2940 contains the likelihoods of each unique {sub-word, phoneme, tag} triplet after processing through the complete input phonetic dictionary 2920. The final sub-word likelihoods dictionary 2940 may include the complete table of tallies as in 34 or may be pruned to contain only the top-N likely pronunciations to reduce table storage requirements. In one embodiment, if only the most likely final word pronunciation is required, then the sub-word likelihoods dictionary 2940 can be pruned to contain only the top-1 likely pronunciation for each {sub-word, tag} pair.

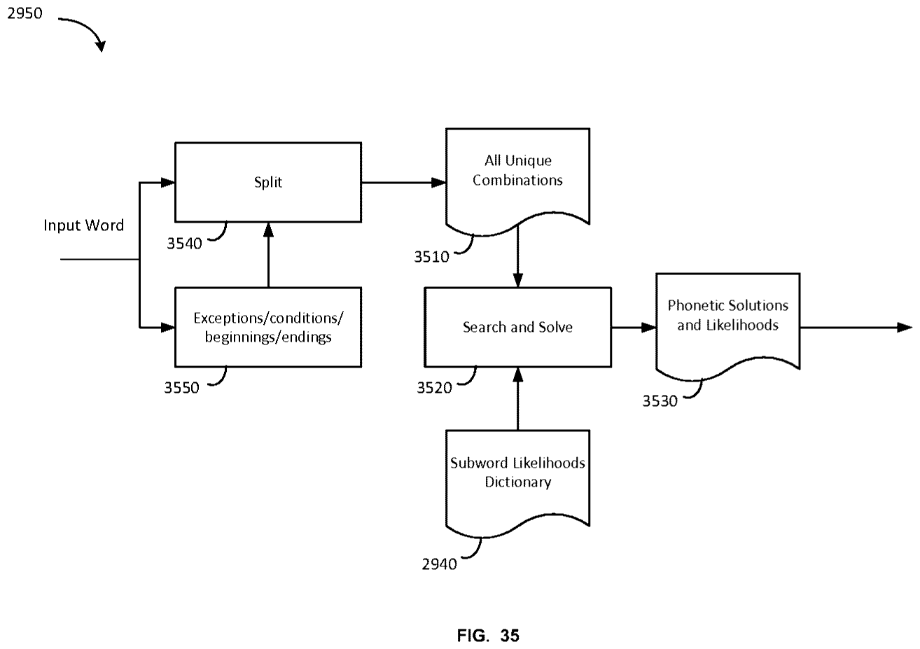

FIG. 35 depicts a block diagram of the decoding phase 2950 of a tokenizer such as the tokenizer 2960 of FIG. 29 using the trained sub-word likelihoods dictionary 2940, in accordance with one aspect of the present disclosure. The tokenizer may analyze an input word, perform a sub-word search, and solve iteratively using the trained sub-word likelihoods dictionary 2940 to maximize the token stream probability. In one aspect, the tokenizer may analyze the text input of WWs and commands in the user-defined command set using the trained sub-word likelihoods dictionary 2940 to tabulate the most likely phoneme string equivalents of the WWs/commands and their likelihoods.

In one embodiment, a split block 3540 may split the grapheme of the unseen input word into different combinations of sub-words. The split block 3540 may be exhaustive, covering every combination of different lengths and numbers of sub-words. In one embodiment, the split block 3540 for the decoding phase may be the same as the split block 3040 used during the training phase.

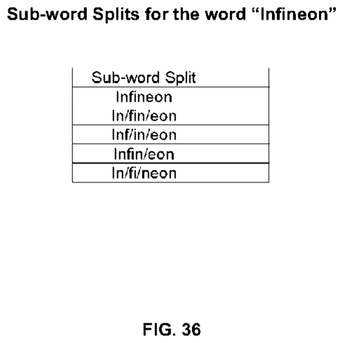

FIG. 36 depicts sub-word splits for the word “Infineon” of the WW “Okay Infineon,” in accordance with one aspect of the present disclosure.

Referring back to FIG. 35, the split block 3540 may consider certain exceptions, conditions, rules for common beginnings/common endings, etc., 3550, when splitting. In one embodiment, the split block 3540 may consider restrictions placed by special combinations of graphemes and common beginnings and endings that should not be split. For example, the ending ‘eon’ in the word “Infineon” should not be split as seen in FIG. 36. The split block 3540 may compile all of the unique sub-word split combinations into a dictionary 3510 for use by other blocks. In one embodiment, the exceptions, conditions, rules for common beginnings/common endings, etc., 3550 used for the decoding phase may be the same as the exceptions, conditions, rules for common beginnings/common endings, etc., 3050 used during the training phase.

A search and solve block 3520 may search through the trained sub-word likelihoods dictionary 2940 for the sub-words contained in each unique sub-word split combination of the input word to find the phonemes corresponding to the sub-words. In one embodiment, the phonemes may be based on the positions associated with the sub-words within the input word. If the search and solve block 3520 finds the phonemes corresponding to all the sub-words of a sub-word split combination in the sub-word likelihoods dictionary 2940, then the combination is solved and the search and solve block 3520 may combine the corresponding phonemes for each sub-word into the corresponding solution.

The phoneme corresponding to each sub-word of the sub-word split combination has a likelihood (probability) found from the sub-word likelihoods dictionary 2940. The search and solve block 3540 may multiply the probabilities for the phonemes corresponding to all the sub-words in each unique combination of sub-word split to obtain the phonetic probability of the combination. The search and solve block 3540 may compile the phonetic probabilities for all unique sub-word split combinations of the input word into a phonetic solutions and likelihoods tabulation 3530. In one embodiment, the phonetic solutions and likelihoods tabulation 3530 may tabulate the sub-word split combination with the most likely phonetic probability among all the combinations to maximize the probability of the phoneme string equivalent for the input word for use in online training of the recognition model for data free speech recognition system. In one embodiment, the phonetic solutions and likelihoods tabulation 3530 may tabulate the sub-word split combinations with the N most-likely phonetic probabilities among all the combinations.

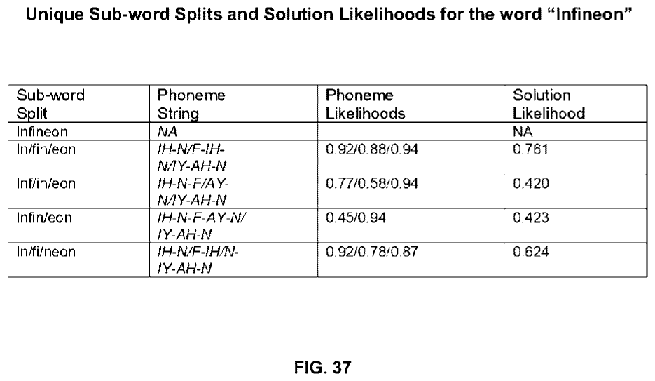

FIG. 37 depicts a tabulation of the sub-word split combinations of the word “Infineon” of FIG. 36, the phonemes of the combinations, the corresponding probabilities of the phonemes of the combinations, and the phonetic probability for the sub-word split combinations, in accordance with one aspect of the present disclosure. The tabulation shows that the most likely phoneme string is “IH/N/F/IH/N/IY/AH/N” and is obtained from the sub-word split combination of “In/fin/eon.”

Advantageously, the approach for training and decoding the statistics-based tokenizer as described yields high transcription accuracy. The approach can support tokens other than phonemes. The training phase with different phonetic libraries can support different accents, dialects, and languages without requiring any additional training data. The training phase can also support small sized phonetic dictionaries for languages with limited phonetic dictionary support. The decoding phase can identify the most likely pronunciation or the N most-likely pronunciations making the approach attractive for a data free speech recognition system.

In one aspect, after the training and decoding phases of the tokenizer, the data free speech recognition system may use the tokenizer to generate strings of phonemes from the user-defined WWs or commands for the online training of the recognition models used during inference. The online training of the recognition models may use the phonemes from the tokenizer and SoftMax vector from the acoustic model to compile statistics. Sequence decoding of the WWs or commands may use the statistics to achieve a highly accurate, robust, phoneme string equivalent for the WWs or commands that is adaptive to the acoustic model and to alternate pronunciations of the WWs or commands.

In one aspect, a text-to-speech (TTS) engine may generate synthetic speech to modify/enhance the speech recognition model (e.g., HMM model) of the data free speech recognition system. As discussed in FIG. 3, to improve the performance of the recognition model 350, the model construction block 344 may utilize TTS 346 to generate synthetic speech containing the target WWs and commands during online training of the recognition model 350. The analysis module 348 may analyze the synthetic speech to aid the model construction block 344 when generating the recognition model 350. In one embodiment, during online training of the recognition models 350 using the synthetic speech from the TTS 346 and SoftMax vector from the acoustic model 218, the model construction block 344 may compile statistics. In one embodiment, the statistics may include the top-N statistics of the phonemes of the target phrases of FIG. 21 (e.g., alternate pronunciations) and the expected length of phonemes of the target phrases for self-transition probabilities. The decoding compensation analysis block 740 of FIG. 15 may use the compiled statistics to improve the sequence decoding of the target phrases.

TTS engines based on machine learning or deep learning may produce excellent synthetic speech quality that is barely discernable from real speech to the untrained listener. They are generally capable of synthesizing hundreds of different talkers, either cloning real target talkers, or generating purely fictional talkers. TTS engines may also target different emotions, accents, and prosodies. While these features increase the variability of the output speech, such variability may still not approach that of real speech. To further increase the statistical variation in the synthetic speech, TTS engines may apply augmentation techniques such as time scale modification, vocal tract normalization, level scaling, etc. An ASP system may use a TTS engine to adapt or train a speech recognition model that is already trained using real speech. Such an approach may be useful when limited real speech data is available for training purposes, for example, on an uncommon language, or for new words in an evolving language. However, when a speech recognition model is trained solely on synthetic speech generated from a TTS, the synthetic-speech training data may be inadequate because the synthetic speech may not accurately represent the desired statistics, spectral content, variability, etc. of real speech.

Described herein is an approach to use a TTS engine to synthesize speech that is otherwise unavailable to train or tune a data free speech recognition system to recognize target phrases in the user-defined command set using only the text or grapheme representation of the target phrases. The data free speech recognition system does not rely on real speech that matches the target phrases, yet may achieve good performance. In one embodiment, the approach may iteratively tune the settings and an augmentation block of a TTS engine to match the target characteristics of real speech and may utilize a compensation block to further compensate/adapt the synthetic speech to real speech.

In one aspect, during online training of the recognition model of the data free speech recognition system, the data free speech recognition system may tune TTS settings and the augmentation block of a TTS engine using an annotated database to derive the compensation block to minimize differences between the synthetic speech and real speech. After the TTS settings and the augmentation block are tuned, the TTS engine may synthesize the target speech from the user-defined WWs and commands to aid the online training of the recognition models of the target phrases.

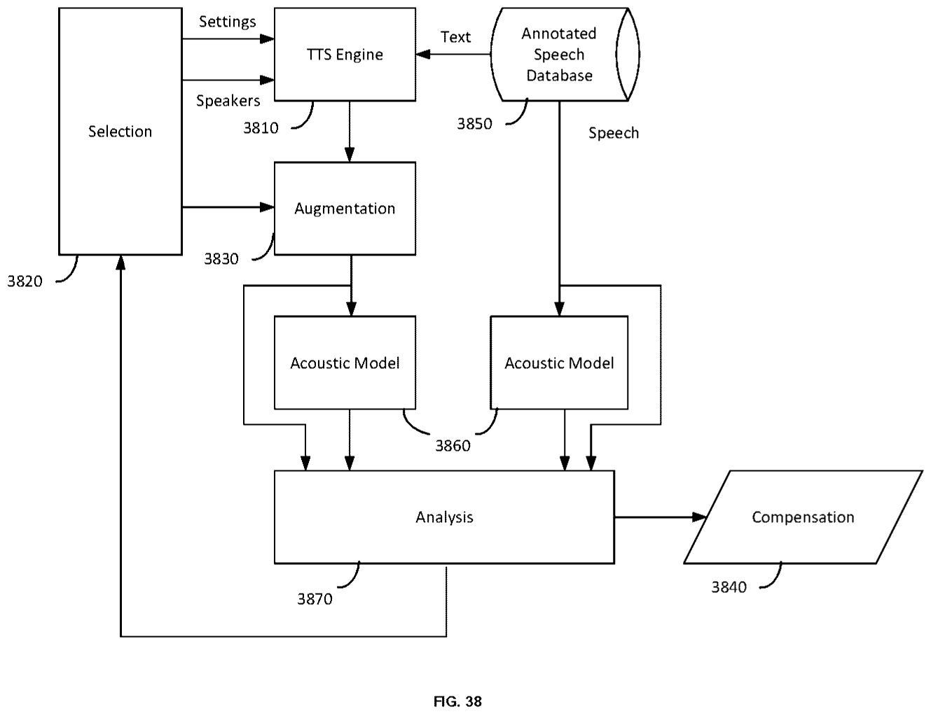

FIG. 38 shows the operating details for tuning a TTS engine of a data free speech recognition system to match the characteristics of the synthetic speech generated by the TTS engine with those of real speech, in accordance with one aspect of the present disclosure. The tuning phase tunes components of a TTS engine 3810 including TTS setting of a selection block 3820 and parameters of an augmentation block 3830 to generate compensation information 3840 to improve the similarity between the synthetic speech and real speech. The output of the tuning phase is the ensemble set of TTS setting of the selection block 3820, augmentation parameters of the augmentation block 3830, and the compensation information 3840.

The tuning phase uses an one or more annotated databases 3850 considered to contain the target or desired characteristics of speech to tune the components. Because the data free speech recognition system lacks speech data specific to the user-defined WWs and commands, the annotated databases 3850 do not contain speech data of the target phrases. Instead, the annotated databases 3850 may contain an ensemble set of talkers representative of a particular language, or a set talkers from a particular region with a desired target accent. For example, the annotated databases 3850 may contain words-token transcriptions (e.g., text-speech) of the ensemble of talkers.

The TTS engine 3810 takes as its input the text of each training segment of the annotated speech databases 3850 to produce the equivalent synthetic speech based on the settings and speaker from the selection block 3820. The TTS engine 3810 may have the ability to synthesize multiple talkers, and/or model different prosodies (rhythm, melody, emphasis, duration, level), etc.

The augmentation block 3830 may process the synthetic speech with augmentation features selected by the selection block 3820 to generate augmented synthetic speech. In one embodiment, the augmentation features may include time scale modification (speed up, slow down), vocal tract length compensation (or other spectral warping), gain scaling, etc.

An acoustic model 3860 such as the acoustic model 218 of FIG. 2 may process both the augmented synthetic speech and the corresponding real speech from the annotated speech databases 3850. An example output of the acoustic model 3860 is a Softmax vector of the phonemes, on a frame-by-frame basis.

An analysis block 3870 compares the output of the synthetic speech and the real speech from the acoustic model 3860. The analysis block 3870 may provide the results of this analysis to the selection block 3820 to adjust the TTS settings and augmentation features. The tuning phase may iterate the TTS setting and augmentation features until convergence of the synthetic speech and the real speech as analyzed by the analysis block 3870. After convergence, the compensation block 3840 may derive compensation or mapping information for use by the data free speech recognition system to further minimize the differences between the synthetic and real speech usage during the online training phase of the recognition models of the target phrases.

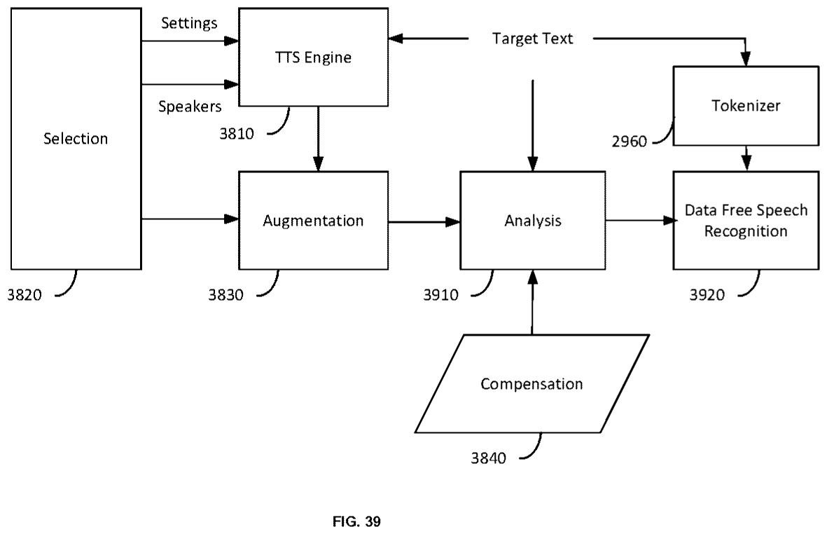

FIG. 39 depicts a block diagram of the training or tuning of the data free speech recognition system using the tuned TTS engine to synthesize speech that is otherwise unavailable to the speech recognition system, in accordance with one aspect of the present disclosure. In one embodiment, the training of the data free recognition system includes the online training of the recognition models as shown in FIG. 3, or the generation of a decoding compensation model to improve the sequence decoding of the WWs or commands, as shown in FIG. 7 or FIG. 15.

In one embodiment, the tuned TTS engine 3810 may synthesize the target speech of the WWs or commands (e.g., the target text) using the ensemble of TTS setting and speakers from the selection block 2920 determined during the tuning phase of the tokenizer. For example, the TTS engine 3810 may be the TTS 346 of FIG. 3 in which the TTS 346 generates synthetic speech containing the target WWs and commands for online training of the recognition model 350.

The augmentation block 3830 may process the synthetic speech with augmentation features again from the selection block 3820 determined during the tuning phase to generate augmented synthetic speech. In one embodiment, the augmentation features may include time scale modification (speed up, slow down), vocal tract length compensation (or other spectral warping), gain scaling, etc. An analysis block 3910 may analyze the augmented synthetic speech to tune or train the data free speech recognition system 3920. For example, the analysis block 3910 may be the analysis module 348 that analyzes the synthetic speech generated by the TTS 346 to aid the generation of the recognition model 350 as shown in FIG. 3. The analysis block 3910 may use the compensation or mapping information from the compensation block 3840 again determined during the tuning phase for use by the data free speech recognition system 3920 to reduce the differences between the synthetic and real speech usage during the online training of the recognition models. In one embodiment, the analysis block 3910 may generate statistics for phonemes of the synthetic speech of the WWs or commands. The data free speech recognition system 3940 may use the statistics of the phonemes in conjunction with the string of phonemes generated by the tokenizer 2960 from the target text to construct the recognition model for the target text. Sequence decoding of the WWs or commands during inference may also use the statistics to improve the discrimination ability of the sequence decoding.

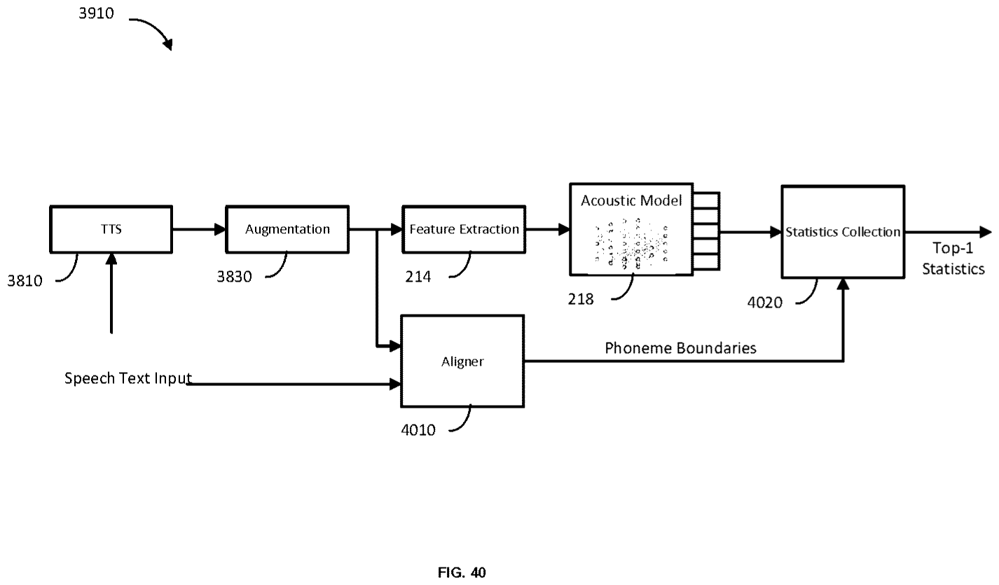

FIG. 40 depicts a block diagram of the analysis block 3910 of FIG. 39 used to analyze synthetic speech to compile statistics for aiding sequence decoding of target speech, in accordance with one aspect of the present disclosure. The TTS engine 3810 may synthesize synthetic speech of the target phrase based on the text input and the augmentation block 3830 may process the synthetic speech with augmentation features to generate augmented synthetic speech as in FIG. 39.

An aligner block 4010 may determine the phonemes of the augmented synthetic speech and their time boundaries. In one embodiment, the aligner block 4010 may use the Montreal Forced Aligner (MFA) to determine the time boundaries of the phonemes. The aligner block 4010 may output the phoneme time boundaries to a statistics collection block 4020.

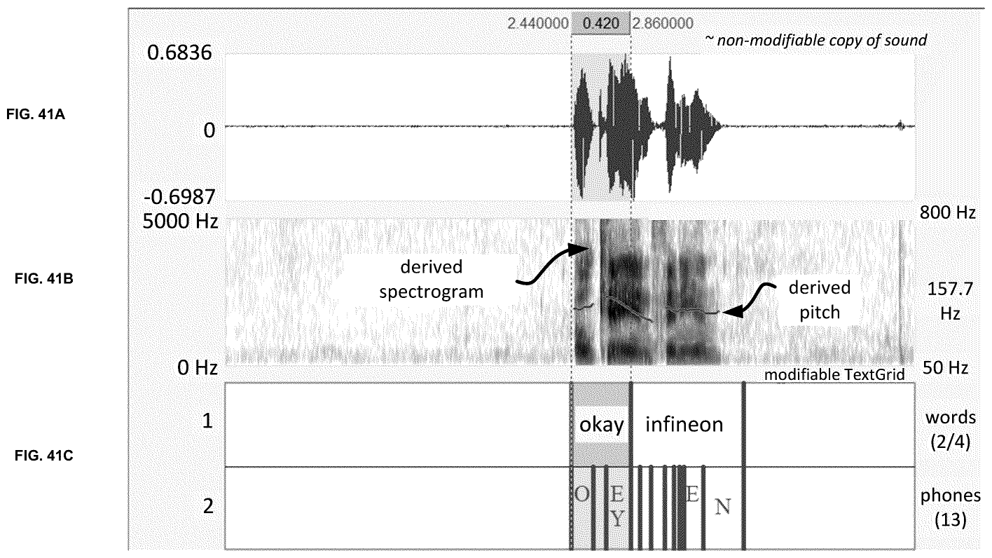

FIG. 41A depicts the time plot for the phonemes of the WW “Okay Infineon,” in accordance with one aspect of the present disclosure. FIG. 41B depicts the spectral plot for the phonemes of the WW “Okay Infineon,” in accordance with one aspect of the present disclosure. FIG. 41C depicts the time boundaries determined by the aligner block 4010 for the phonemes of the WW “Okay Infineon,” in accordance with one aspect of the present disclosure.

Referring back to FIG. 40, the feature extraction block 214 may perform a spectral and temporal analysis of the augmented synthetic speech to produce observation vectors that are consumed by the acoustic model 218. The statistics collection block 4020 may capture the output frame of the acoustic model that most closely aligns with the center of the phoneme boundaries from the aligner block 4010. In one embodiment, the statistics collection block 4020 may capture the output frame of the acoustic models based on majority decision, report all, etc. The statistics collection block 4020 may record the most likely phoneme of this output frame. The statistics collection block 4020 may compile the statistics for each phoneme over the entire set of user-defined WWS and commands to generate the top-1 statistics.

Refer back to FIG. 21 to see the top-1 statistics of the phonemes for the WW ‘Okay Infineon,’ in accordance with one aspect of the present disclosure. The table indicates which phonemes are predicted correctly with what degree of accuracy. For example, the top-1 column shows what percentage of the time that a listed phoneme is reported as the most likely according to the acoustic model Softmax output for the center of the theoretical phoneme of the first column. The noise column specifies what percentage of the time the top phoneme is the noise class. This is ideally zero, with the non-zero values likely due to misalignment of the phoneme boundaries. As such, the table scales the top-1 values by the noise percentage to obtain a better estimate of the true top-1 values. The final column shows the noise scaled total sum percentage for the phonemes listed. For example, for the first ‘N’, the statistics collection block 4020 captures the three most likely phonemes {‘N’, ‘NG,′M’} of the noise scaled values in 78% the cases, giving a relatively high confidence in the top phoneme reported by the acoustic model 218 when processing the first phoneme ‘N.’ In contrast, for the second to last phoneme ‘EH’, the statistics collection block 4020 captures the eleven most likely phonemes of the noise scaled values spread out over 86% of the cases, giving a relatively low confidence in the top phoneme reported by the acoustic model 218 when processing the last phoneme ‘EH.’

In one embodiment, the HMM for a target phrase may use the top-1 statistics to support alternate pronunciations by allowing multiple phonemes in each state definition, as shown for states 1320 and 1330 in FIG. 13. In one embodiment, the decoding compensation analysis block 740 of FIG. 15 may use the top-1 statistics to weigh how well the most likely state matches the expected phonemes of the target phrase to improve the sequence decoding of the target phrase, as discussed.

In one aspect, an offline analysis may compute the average length (in time) of each phoneme using the annotated database used for training the acoustic model, such as the phoneme annotated database 320 of FIG. 3.

In one embodiment, if the starting time of i^{th} occurrence of phoneme phⱼ is

$${s}_{{ph}_{j}}^{i}$$

and the ending time is

$${e}_{{ph}_{j}}^{i} ,$$

then average length L̅ₚₕ_{ⱼ} for phoneme phⱼ is given by:

$${\overline{L}}_{{ph}_{j}} = \frac{1}{{N}_{ph}} \cdot {\sum }_{i = 1}^{{N}_{ph}} {e}_{{ph}_{j}}^{i} - {s}_{{ph}_{j}}^{i} . \qquad ( Equation 26 )$$

where Nₚₕ is the number occurrences of the phoneme phⱼ used in the average.

The self-transition analysis block 1530 of the decoding compensation analysis block 740 of FIG. 15 may compute the self-transition probabilities for the states of the HMM for a target phrase based on the expected length in time of the phonemes according to Equation 19 reproduced below:

$$P ( {s}_{j} \vert {s}_{j} ) = 1 - \frac{{t}_{frame}}{{\overline{L}}_{{ph}_{j}}} \qquad ( Equation 19 )$$

where t_{frame} is the time (in seconds) for each frame and L̅ₚₕ_{ⱼ} is the average length (in seconds) for the phoneme in j^{th} state of the HMM. The decoding compensation analysis block 740 may use the self-transition probabilities for the states of the HMM to improve the sequence decoding of the target phrase, as discussed.

In one embodiment, as an alternative to computing the average length of each phoneme in the annotated database used for training the acoustic model, an offline analysis may use the synthetic speech. The offline analysis may use the synthetic speech in conjunction with the phoneme boundaries for the phonemes as that described for compiling the top-1 statistics of FIG. 40. The statistics collection block 4020 may compute the length of each phoneme to find the averages. This approach has the advantage of finding the phoneme length specific to when it is found in the given target phrase, instead of a global average. In addition, any discrepancy or bias between the duration for each phoneme in synthetic speech vs. real speech can be compensated when using the decoding compensation analysis block 740.

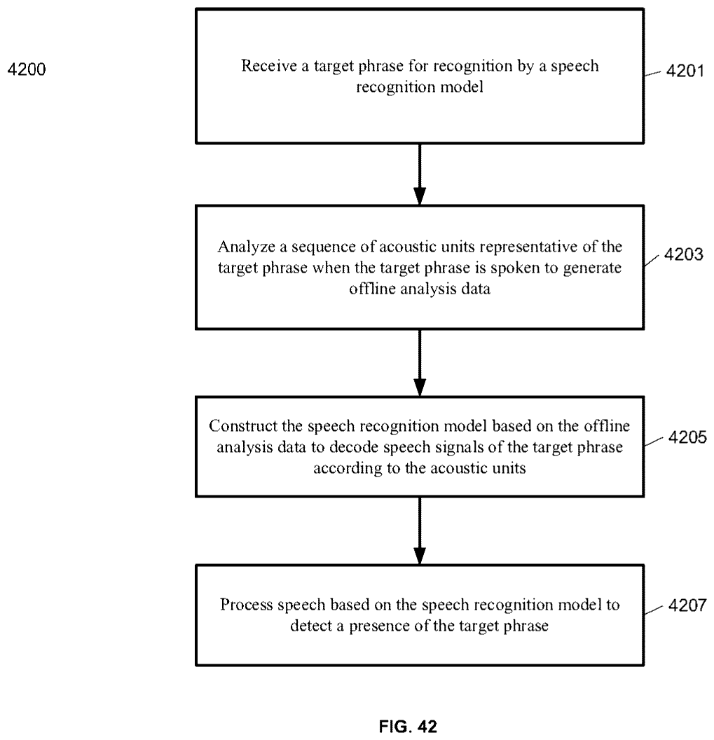

FIG. 42 illustrates a flow diagram of a method 4200 for operating a data free speech recognition system, in accordance with one aspect of the present disclosure. In one aspect, method 1100 may be performed by the systems or devices of FIG. 1-7, 12, 22, 28-31, 36, 39-40, or 43 utilizing hardware, software, or combinations of hardware and software.

In operation 4201, the system receives a target phrase for recognition by a speech recognition model.

In operation 4203, the system analyzes a sequence of acoustic units representative of the target phrase when the target phrase is spoken to generate offline analysis data.

In operation 4205, the system constructs the speech recognition model based on the offline analysis data to decode speech signals of the target phrase according to the acoustic units.

In operation 4207, the system processes speech based on the speech recognition model to detect a presence of the target phrase

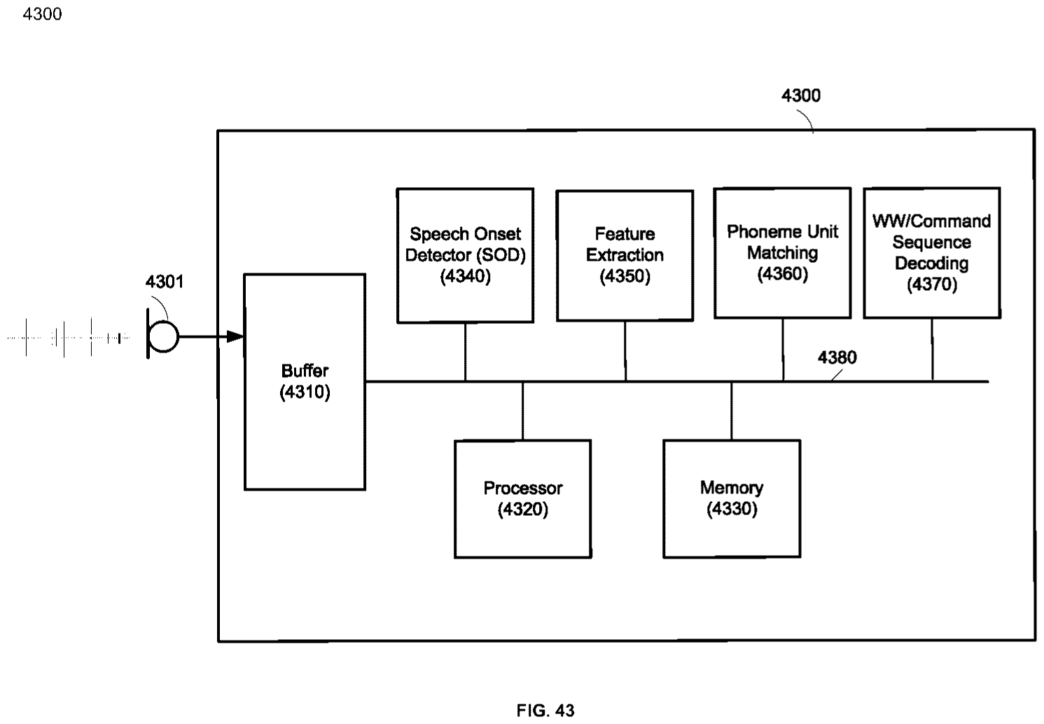

FIG. 43 illustrates a data processing system 4300 that implements a data free speech recognition system, in accordance with one aspect of the present disclosure. For example, the data processing system 4300 may implement any of the operations described herein, including the offline training of an acoustic model, online training of a decoding model, tuning of a tokenizer, and inference operation for a data free speech recognition system shown in FIGS. 2-7, 12-13, 15, 22, 24-31, 36, 39-40, and 42. In one embodiment, the data processing system 4300 may implement the operations on smartphones, desktop computers, laptops, home assistant devices, other voice-controlled devices, servers, etc.

A microphone 4301 of the data processing system 4300 may capture audio signals to store an input signal containing noise and target speech to a buffer 4303. In one embodiment, an input terminal (not shown) of the processing system 4300 may receive audio signals captured by one or more external microphones to store in the buffer 4303.

A processor 4320 may read the captured audio signals from the buffer for processing. The processor 4320 may retrieve computer-readable instructions from the memory 4330 to execute the instructions to perform the operations described above. The processor 4320 may contain one or more processing cores. The memory 4330 may include one or more ROMs (read only memories), volatile random access memories (RAMs), and/or other types of memories. Communication between the buffer 4310, processor 4320, and memory 4330 may take place through a communication bus 4380.

In one aspect, during offline training of an neural network-based acoustic model, the processor 4320 may perform feature extraction of input speech from a phoneme annotated database to generate observation vectors, iterate the acoustic model through the observation vectors to learn to distinguish the input speech according to phonemes, and analyze the vectors of phonemes from the acoustic model to generate a similarity matrix.

In one aspect, during the online training of a decoding model, the processor 4320 may implement a tokenizer to convert text of user-defined WWs/commands to phoneme sequences, and may train the decoding model based on the phoneme sequences of the WWs/commands and the similarity matrix from the offline training.

In one aspect, during the inference stage of the data free speech recognition system, the processor 4320 may implement SOD algorithm to detect active speech, perform feature extraction of the active speech to generate observation vectors, invoke the acoustic model based on the observation vectors to generate Softmax vectors, and apply statistical modeling on the Softmax vectors according to the decoding model to determine if a user-defined WW or command is spoken.

In one aspect, the processor 4320 may tune a TTS engine to match the characteristics of real speech using a training phase and a decoding phase. For example, during the tuning of the TTS engine, the processor 4320 may use an annotated speech database to tune the TTS settings, augmentation parameters, and compensation block of the TTS engine to minimize differences between synthetic speech generated by the TTS engine and real speech.

In one aspect, the processor 4320 may train a tokenizer by applying words from a reference phonetic dictionary to the tokenizer to generate a custom dictionary containing sub-words and their estimated likelihoods. During the decoding phase of the tokenizer, the processor 4320 may invoke the tokenizer to analyze the text input of user-defined WWs/commands using the custom dictionary of sub-words and their estimated likelihoods to tabulate the most likely phoneme string equivalents of the text input and their likelihoods, which may be used for online training of the decoding model.

Various embodiments of the data free speech recognition system described herein may include various operations. These operations may be performed and/or controlled by hardware components, digital hardware and/or firmware/programmable registers (e.g., as implemented in computer-readable medium), and/or combinations thereof. The methods and illustrative examples described herein are not inherently related to any particular device or other apparatus. For example, during the inference stage of the data free speech recognition system, the processor 4320 may invoke a SOD block 4340 to detect active speech, a feature extraction block 4350 to perform feature extraction of the active speech to generate observation vectors, a phoneme unit matching block 4360 to generate Softmax vectors based on the observation vectors, and a WW/command sequence decoding block 4370 that applies statistical modeling on the Softmax vectors to determine if a user-defined WW or command is spoken. The required structure for a variety of these systems will appear as set forth in the description above.

A computer-readable medium used to implement operations of various aspects of the disclosure may be non-transitory computer-readable storage medium that may include, but is not limited to, electromagnetic storage medium, magneto-optical storage medium, ROM, RAM, erasable programmable memory (e.g., EPROM and EEPROM), flash memory, or another now-known or later-developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, unprogrammed programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of speech recognition by a device, the method comprising:
receiving a target phrase for recognition by a speech recognition model;
analyzing a sequence of acoustic units representative of the target phrase when the target phrase is spoken to generate offline analysis data;
constructing the speech recognition model based on the offline analysis data to decode speech signals of the target phrase according to the acoustic units; and
processing speech based on the speech recognition model to detect a presence of the target phrase.

2. The method of claim 1, wherein processing speech based on the speech recognition model comprises:
determining from the speech recognition model a model likelihood score representing a likelihood of the presence of the target phrase based on an observed sequence of acoustic units decoded from the speech.

3. The method of claim 2, wherein processing speech based on the speech recognition model further comprises:
modifying the model likelihood score based on the observed sequence of acoustic units and the offline analysis data to determine the presence of the target phrase.

4. The method of claim 1, wherein the speech recognition model comprises a sequence of decoding states, wherein each decoding state of the sequence of decoding states models each acoustic unit of the sequence of acoustic units, and wherein analyzing the sequence of acoustic units comprises:
determining an order of transitioning through the sequence of decoding states based on time.

5. The method of claim 1, wherein the target phrase comprises a plurality of words, and wherein the offline analysis data comprises an expected length in time of the target phrase and an expected length in time of each of the plurality of words when the target phrase is spoken.

6. The method of claim 1, wherein the speech recognition model comprises a sequence of states, wherein each state of the sequence of states models each acoustic unit of the sequence of acoustic units, and wherein processing speech based on the speech recognition model comprises determining a likelihood of the presence of the target phrase based on an order of transitions between states of the sequence of states when the target phrase is spoken.

7. The method of claim 1, wherein the offline analysis data comprises an expected length in time of each of the acoustic units in the sequence of acoustic units.

8. The method of claim 7, wherein the speech recognition model comprises a sequence of decoding states, wherein each decoding state of the sequence of decoding states models each acoustic unit of the sequence of acoustic units, and wherein the expected length in time of each of the acoustic units comprises an expected length in time the speech recognition model stays in each of the decoding states when decoding speech signals of the target phrase.

9. The method of claim 1, wherein the speech recognition model comprises a sequence of decoding states, wherein each decoding state of the sequence of decoding states models each acoustic unit of the sequence of acoustic units, and wherein the offline analysis data comprises:
one or more acoustically similar acoustic units to an acoustic unit modeled by a decoding state, wherein the acoustically similar acoustic units are associated with probability estimates of a presence of the acoustically similar acoustic units when the decoding state identifies the acoustic unit modeled by the decoding state as a most likely acoustic unit.

10. The method of claim 1, wherein constructing the speech recognition model based on the offline analysis data comprises:
constructing a sequence decoding model based on the sequence of acoustic units, wherein the sequence decoding model includes a sequence of states, and wherein each state of the sequence of states models each acoustic unit of the sequence of acoustic units; and
constructing a decoding compensation model based on the offline analysis data to modify a decoding output of the sequence decoding model.

11. The method of claim 10, wherein the sequence decoding model decodes a most likely path through the sequence of states when processing speech, and wherein the decoding compensation model compares transitions through the sequence of states of the most likely path with expected transitions through the sequence of states when the speech recognition model processes acoustic units of the target phrase.

12. The method of claim 11, wherein the expected transitions through the sequence of states comprises at least one of:
a ratio between an expected length in time of a word in the target phrase and an expected total length in time of the target phrase when the target phrase is spoken;
an expected transition of 1 state through the sequence of states when the target phrase is spoken;
an expected length in time in each state of the sequence of states when the target phrase is spoken; or
acoustically similar acoustic units to an acoustic unit that is modeled by each state of the sequence of states, wherein each of the acoustically similar acoustic units is associated with a probability estimate of a detection when the acoustic unit is modeled by a corresponding state.

13. The method of claim 12, wherein processing speech based on the speech recognition model comprises at least one of:
comparing a ratio of an observed length in time of a word in the speech and an observed total length in time of the speech when transitioning through the sequence of states of the most likely path with the ratio between an expected length in time of a word in the target phrase and an expected total length in time of the target phrase to generate a word-ratio penalty;
comparing observed state jumps when transitioning through the sequence of states of the most likely path with the expected transition of 1 state for the target phrase to generate a state jump penalty;
comparing an observed length in time in each state when transitioning through the sequence of states of the most likely path with the expected length in time in each state of the target phrase to generate a state walk penalty; or
comparing a probability estimate of a most likely acoustic unit modeled by each state when transitioning through the sequence of states of the most likely path with probability estimates for the acoustically similar acoustic units and the acoustic unit modeled by each state for the expected transitions of the target phrase to generate a top-1 penalty.

14. The method of claim 13, wherein the state walk penalty is weighted by a probability of transitioning within each state for the expected transitions of the target phrase.

15. The method of claim 13, wherein the top-1 penalty for a state is weighted by a probability estimate of the acoustic unit modeled by the state to reward the most likely acoustic unit that matches the acoustic unit modeled by the state, and to penalize the most likely acoustic unit that fails to match the acoustic unit modeled by the state, when a probability estimate of the acoustic unit modeled by the state is high.

16. The method of claim 13, wherein processing speech based on the speech recognition model comprises:
combining the word-ratio penalty, the state jump penalty, the state walk penalty, and the top-1 penalty to generate a total compensation; and
modifying a score associated with the most likely path by the total compensation to generate a modified score indicating a probability of the presence of the target phrase.

17. The method of claim 1, wherein the target phrase comprises at least one of:
a wake-word spoken to address the device;
a simple command spoken following the wake-word, wherein the simple command includes one or more words;
a compound command spoken following the wake-word, wherein the compound command includes a common sub-command and a second sub-command unique to each compound command;
a number and an associated unit spoken following the wake-word; or
a complex command spoken following the wake-word, wherein the complex command includes a combination of any one of the simple command, the compound command, and the number and the associated unit.

18. The method of claim 17, wherein constructing the speech recognition model based on the offline analysis data comprises:
constructing a sequence decoding model based on a sequence of acoustic units of the wake-word followed by a sequence of acoustic units of a command, wherein the sequence decoding model models a first sequence of states corresponding to the sequence of acoustic units of the wake-word and a second sequence of states corresponding to the sequence of acoustic units of the command, and wherein a state of the first sequence of states corresponding to a last acoustic unit of the wake-word also models a gap between the wake-word and the command.

19. The method of claim 17, wherein constructing the speech recognition model based on the offline analysis data comprises:
constructing a sequence decoding model based on a concatenation of sequences of acoustic units of a plurality of words of a command, wherein the sequence decoding model includes a first sequence of states modeling a sequence of acoustic units of a first word, an silence state modeling a gap between the first word and a second word of the command, and a second sequence of states modeling a sequence of acoustic units of the second word, and wherein the silence state also models a last acoustic unit of the first word and a first acoustic unit of the second word.

20. An apparatus comprising:
an input terminal configured to receive an audio signal from one or more microphones; and
a processing system configured to:
receive a target phrase for recognition by a speech recognition model;
analyze a sequence of acoustic units representative of the target phrase when the target phrase is spoken to generate offline analysis data;
construct the speech recognition model based on the offline analysis data to decode speech signals of the target phrase according to the acoustic units; and
process the audio signal based on the speech recognition model to detect a presence of the target phrase.
